(19) United States
(12) Patent Application Publication
(10) Pub. No.: US 2025/0164673 A1
(43) Pub. Date: May 22, 2025

(54) LIGHT SHIELDING ARTICLES AND ELECTROMAGNETIC RECEIVERS AND/OR EMITTERS INCLUDING THE SAME

(71) Applicant: 3M INNOVATIVE PROPERTIES COMPANY, St. Paul, MN (US)

(72) Inventors: Sean M. Sweetnam, Minneapolis, MN (US); Andrew C. Smith, Cottage Grove, MN (US); Stephen P. Maki, North St. Paul, MN (US); David J. Rowe, Roseville, MN (US); Timothy J. Hebrink, Scandia, MN (US); Daniel M. Pierport, North St. Paul, MN (US); Kevin W. Gotrik, Hudson, WI (US); Mark D. Weigel, Hugo, MN (US); James A. Phipps, River Falls, WI (US); Kevin D. Hagen, St. Paul, MN (US); Mark B. O'Neill, Stillwater, MN (US)

(21) Appl. No.: 18/841,431

(22) PCT Filed: Apr. 17, 2023
(86) PCT No.: PCT/IB2023/053920

§ 371 Date: Aug. 26, 2024

Related U.S. Application Data
(60) Provisional application No. 63/343,674, filed on May 19, 2022.
(60) Provisional application No. 63/417,171, filed on Oct. 18, 2022.

(51) Int. Cl. G02B 5/08

(52) U.S. Cl. CPC G02B 5/0841

(57) ABSTRACT

Light shielding articles are provided. Light shielding articles include a first multilayer optical film comprised of alternating first and second polymeric optical layers collectively reflecting at an incident light angle of at least one of 0°, 15°, 30°, 45°, 60°, or 75°, an average of at least 70, 80, 90, or 95 percent of incident visible light over at least a wavelength range from 400 nanometers (nm) to 700 nm. The light shielding articles further include either a second multilayer optical film or a barrier coating disposed on the first multilayer optical film. The light shielding article transmits at an incident light angle of at least one of 0°, 15°, 30°, 45°, 60°, or 75°, an average of at least 70, 80, 90, or 95 percent of incident radio frequency waves in at least one wavelength range from 1 mm to 10 mm, 10 mm to 100 mm, or 100 mm to 1000 mm. Additionally, an electromagnetic receiver and/or emitter is provided that includes a light shielding article according attached to at least a portion of the electromagnetic receiver and/or emitter.

### BACKGROUND

There is a class of telecommunications network with infrastructure provided by constellations of thousands of small satellites deployed in low earth orbit. These satellites use antennas to transmit and receive electromagnetic telecommunication signals. These antennas generate significant heat during operation, and are additionally heated through exposure to solar radiation. This heat is difficult to manage in the vacuum of space where common heat management effects like convection cannot occur due to the minimal presence of gas particles. One strategy to help manage heat is to cover the satellites with reflective films which reject solar energy, thereby rejecting a significant source of thermal energy. However, the devices typically operate at altitudes ranging from 20-2000 km, where the thin atmosphere absorbs little solar radiation. The high-altitude devices are thus exposed to the more intense AM0 solar spectrum and to a higher intensity of ultraviolet (UV) radiation, particularly UV-C radiation, than is present in the AM1.5 solar spectrum encountered in Earth terrestrial conditions. The high-altitude devices also may be exposed to atomic oxygen which can damage oxygen-sensitive electronic components.

### SUMMARY

In a first aspect, a light shielding article is provided. The light shielding article includes a) a first multilayer optical film comprised of at least a plurality of alternating first and second polymeric optical layers collectively reflecting at an incident light angle of at least one of 0°, 15°, 30°, 45°, 60°, or 75°, an average of at least 70, 80, 90, or 95 percent of incident visible light over at least a wavelength range from 400 nanometers (nm) to 700 nm, the multilayer optical film having a first major surface; and b) a second multilayer optical film disposed on the first multilayer optical film, the second multilayer optical film comprised of at least a plurality of alternating first and second inorganic optical layers collectively reflecting and absorbing at an incident light angle of at least one of 0°, 15°, 30°, 45°, 60°, or 75°, an average of at least 50, 60, 70, 80, 90, or 95 percent of incident ultraviolet light over at least a 30-nanometer wavelength reflection bandwidth in a wavelength range from 190 nm to 400 nm. The light shielding article transmits at an incident light angle of at least one of 0°, 15°, 30°, 45°, 60°, or 75°, an average of at least 70, 80, 90, or 95 percent of incident radio frequency waves in at least one wavelength range from 1 millimeter (mm) to 10 mm, 10 mm to 100 mm, or 100 mm to 1000 mm.

In a second aspect, another light shielding article is provided. The light shielding article includes a) a first multilayer optical film comprised of at least a plurality of alternating first and second polymeric optical layers collectively reflecting at an incident light angle of at least one of 0°, 15°, 30°, 45°, 60°, or 75°, an average of at least 70, 80, 90, or 95 percent of incident visible light over at least a wavelength range from 400 nanometers (nm) to 700 nm, the multilayer optical film having a first major surface; and b) a barrier coating disposed on the first major surface of the multilayer optical film, the barrier coating comprising: at least one dyad comprised of a (co)polymer layer overlaying the first major surface of the multilayer optical film and an inorganic layer overlaying the (co)polymer layer; and an outer (co)polymer layer overlaying the at least one dyad; and optionally, at least one outer inorganic layer overlaying the outer (co)polymer layer. The light shielding article transmits at an incident light angle of at least one of 0°, 15°, 30°, 45°, 60°, or 75°, an average of at least 70, 80, 90, or 95 percent of incident radio frequency waves in at least one wavelength range from 1 mm to 10 mm, 10 mm to 100 mm, or 100 mm to 1000 mm. The light shielding article transmits, at an incident light angle of at least one of 0°, 15°, 30°, 45°, 60°, or 75°, an average of at most 50, 60, or 70 percent of incident ultraviolet light over at least a 30-nanometer wavelength reflection bandwidth in a wavelength range from 190 nm to 400 nm.

In a third aspect, an electromagnetic receiver and/or emitter is provided. The electromagnetic receiver and/or emitter includes the light shielding article according to the first aspect or the second aspect attached to at least a portion of the electromagnetic receiver and/or emitter.

Various unexpected results and advantages are obtained in exemplary embodiments of the disclosure. One such advantage of exemplary embodiments of the present disclosure is the provision of an article that provides shielding from wavelengths within both the visible and UV ranges while allowing transmission of wavelengths within the radio frequency (RF) range. In some cases, light shielding articles according to the present disclosure provide broadband shielding in the UV range, in the visible range, or both.

Further, light shielding articles that include a barrier coating provide protection from atomic oxygen environments. Additionally, the combination of UV absorption and reflection in light shielding articles that include the second multilayer optical film creates a broadband UV rejection filter made from durable inorganic materials that can survive in low earth orbit conditions. The layers can be sputter deposited or evaporated in a roll-to-roll process. As such, a further advantage of exemplary embodiments is to enable a high speed, roll-to-roll continuous production process for at least certain embodiments of light shielding articles of the present disclosure.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 is a schematic cross-sectional view of an exemplary light shielding article 10 and an exemplary electromagnetic receiver and/or emitter 40, according to various exemplary embodiments disclosed herein.

FIG. 2 is a schematic cross-sectional view of another exemplary light shielding article 10 and another exemplary electromagnetic receiver and/or emitter 40, according to various exemplary embodiments disclosed herein.

In the drawings, like reference numerals indicate like elements. While the above identified drawings, which may not be drawn to scale, set forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that:

The term “fluoropolymer” refers to any organic polymer containing fluorine.

The term “nonfluorinated” means not containing fluorine.

The terms “(co)polymer” or “(co)polymers” includes homo(co)polymers and (co)polymers, as well as homo(co)polymers or (co)polymers that may be formed in a miscible blend, (e.g., by coextrusion or by reaction, including, (e.g., transesterification)). The term “(co)polymer” includes random, block and star (co)polymers.

As used herein, “adjacent” encompasses both in direct contact (e.g., directly adjacent) and having one or more intermediate layers present between the adjacent materials.

As used herein, “incident” with respect to light refers to the light falling on or striking a material.

The term “crosslinked” (co)polymer refers to a (co)polymer whose (co)polymer chains are joined together by covalent chemical bonds, usually via crosslinking molecules or groups, to form a network (co)polymer. A crosslinked (co)polymer is generally characterized by insolubility but may be swellable in the presence of an appropriate solvent.

The term “cure” refers to a process that causes a chemical change, (e.g., a reaction that creates a covalent bond to solidify a multilayer film layer or increase its viscosity.

The term “cured (co)polymer” includes both crosslinked and uncrosslinked (co)polymers.

The term “metal” includes a pure metal or a metal alloy.

The term “film” or “layer” refers to a single stratum within a multilayer film.

The term “(meth)acryl” or “(meth)acrylate” with respect to a monomer, oligomer, (co)polymer or compound means a vinyl-functional alkyl ester formed as the reaction product of an alcohol with an acrylic or a methacrylic acid.

The term “optically clear” refers to an article in which there is no visibly noticeable distortion, haze or flaws as detected by the naked eye at a distance of about 1 meter, preferably about 0.5 meters.

The term “optical thickness” when used with respect to a layer refers to the physical thickness of the layer times its in-plane index of refraction.

The term “vapor coating” or “vapor depositing” means applying a coating to a substrate surface from a vapor phase, for example, by evaporating and subsequently depositing onto the substrate surface a precursor material to the coating or the coating material itself. Exemplary vapor coating processes include, for example, physical vapor deposition (PVD), chemical vapor deposition (CVD), and combinations thereof.

By using the term “overlaying” or “overcoated” to describe the position of a layer with respect to a dyad or different layer of an article of the present disclosure, we refer to the layer as being atop the dyad or different layer, but not necessarily contiguous to or in contact with the dyad or different layer, although the layer may, in some embodiments, be in direct contact with the dyad or other layer.

By using terms of orientation such as “atop”, “on”, “over,” “covering”, “uppermost”, “underlying” and the like for the location of various elements in the disclosed coated articles, we refer to the relative position of an element with respect to a horizontally-disposed, upwardly-facing substrate. However, unless otherwise indicated, it is not intended that the substrate or articles should have any particular orientation in space during or after manufacture, or in interpreting the claims.

As used herein, “radiation” refers to electromagnetic radiation unless otherwise specified.

As used herein, “scattering” with respect to wavelengths of light refers to causing the light to depart from a straight path and travel in different directions with different intensities.

As used herein, “reflectance” is the measure of the proportion of light or other radiation striking a surface at normal incidence which is reflected off it. Reflectivity typically varies with wavelength and is reported as the percent of incident light that is reflected from a surface (0 percent—no reflected light, 100—all light reflected. Reflectivity and reflectance are used interchangeably herein.

As used herein, “reflective” and “reflectivity” refer to the property of reflecting light or radiation, especially reflectance as measured independently of the thickness of a material.

As used herein, “average reflectance” refers to reflectance averaged over a specified wavelength range.

As used herein, “absorption” refers to a material converting the energy of light radiation to internal energy.

As used herein, “absorb” with respect to wavelengths of light encompasses both absorption and scattering, as scattered light also eventually gets absorbed. Absorbance can be measured with methods described in ASTM E903-12 “Standard Test Method for Solar Absorptance, Reflectance, and Transmittance of Materials Using Integrating Spheres”. Absorbance measurements described herein were made by making transmission measurements as previously described and then calculating absorbance using Equation 1.

As used herein, the term “absorbance” with respect to a quantitative measurement refers to the base 10 logarithm of a ratio of incident radiant power to transmitted radiant power through a material. The ratio may be described as the radiant flux received by the material divided by the radiant flux transmitted by the material. Absorbance (A) may be calculated based on internal transmittance (T) according to Equation 1:

$$A = - {log}_{10} T \qquad ( 1 )$$

Emissivity can be measured using infrared imaging radiometers with methods described in ASTM E1933-14 (2018) “Standard Practice for Measuring and Compensating for Emissivity Using Infrared Imaging Radiometers.” According to Kirchhoff's law of thermal radiation, absorbance correlates with emittance. Absorbance, absorptivity, emissivity, and emittance are used interchangeably herein for the same purpose of emitting infrared energy to the atmosphere. Absorb and emit are also used interchangeably herein.

As used herein, the terms “transmittance” and “transmission” refer to the ratio of total transmission of a layer of a material compared to that received by the material, which may account for the effects of absorption, scattering, reflection, etc. Transmittance (T) may range from 0 to 1 or be expressed as a percentage (T %).

As used herein, “transparent” refers to a material (e.g., film or layer) that absorbs less than 20% of light having wavelengths between 350 nm and 2500 nm.

As used herein, “bandwidth” refers to a width of a contiguous band of wavelengths.

The terms “about” or “approximately” with reference to a numerical value or a shape means +/− five percent of the numerical value or property or characteristic, but expressly includes the exact numerical value.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g., visible light) than it fails to transmit (e.g., absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

By definition, the total weight percentages of all ingredients in a composition equals 100 weight percent.

Various exemplary embodiments of the disclosure will now be described. Exemplary embodiments of the present disclosure may take on various modifications and alterations without departing from the spirit and scope of the present disclosure. Accordingly, it is to be understood that the embodiments of the present disclosure are not to be limited to the following described exemplary embodiments but is to be controlled by the limitations set forth in the claims and any equivalents thereof.

### Light Shielding Article

In a first aspect, a light shielding article is provided. The light shielding article comprises: a) a first multilayer optical film comprised of at least a plurality of alternating first and second polymeric optical layers collectively reflecting at an incident light angle of at least one of 0°, 15°, 30°, 45°, 60°, or 75°, an average of at least 70, 80, 90, or 95 percent of incident visible light over at least a wavelength range from 400 nanometers (nm) to 700 nm, the multilayer optical film having a first major surface; and

b) a second multilayer optical film disposed on the first multilayer optical film, the second multilayer optical film comprised of at least a plurality of alternating first and second inorganic optical layers collectively reflecting and absorbing at an incident light angle of at least one of 0, 15°, 30°, 45°, 60°, or 75°, an average of at least 50, 60, 70, 80, 90, or 95 percent of incident ultraviolet light over at least a 30-nanometer wavelength reflection bandwidth in a wavelength range from 190 nm to 400 nm,

wherein the light shielding article transmits at an incident light angle of at least one of 0, 15°, 30°, 45°, 60°, or 75°, an average of at least 70, 80, 90, or 95 percent of incident radio frequency waves in at least one wavelength range from 1 millimeter (mm) to 10 mm, 10 mm to 100 mm, or 100 mm to 1000 mm.

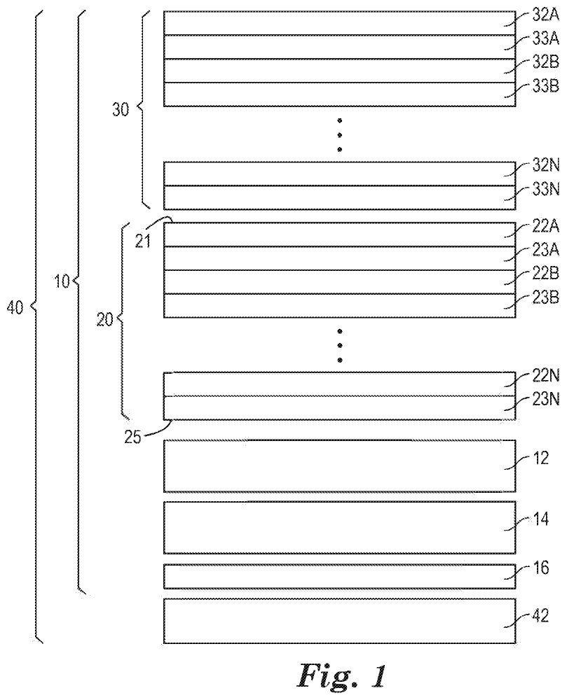

Referring now to FIG. 1, the present disclosure describes light shielding articles 10 including a first multilayer optical film 20 and a second multilayer optical film 30 disposed on a first major surface 21 of the first multilayer optical film 20. The first multilayer optical film 20 is comprised of at least a plurality of alternating first polymeric optical layers 23 (A-N) and second polymeric optical layers 22 (A-N) collectively reflecting at an incident light angle of at least one of 0°, 15°, 30°, 45°, 60°, or 75°, an average of at least 70, 80, 90, or 95 percent of incident visible light over at least a wavelength range from 400 nanometers (nm) to 700 nm. The second multilayer optical film 30 is comprised of at least a plurality of alternating first inorganic optical layers 33 (A-N) and second inorganic optical layers 32 (A-N) collectively reflecting and absorbing at an incident light angle of at least one of 0°, 15°, 30°, 45°, 60°, or 75°, an average of at least 50, 60, 70, 80, 90, or 95 percent of incident ultraviolet light over at least a 30-nanometer wavelength reflection bandwidth in a wavelength range from 190 nm to 400 nm. The light shielding article 10 transmits at an incident light angle of at least one of 0°, 15°, 30°, 45°, 60°, or 75°, an average of at least 70, 80, 90, or 95 percent of incident radio frequency waves in at least one wavelength range from 1 millimeter (mm) to 10 mm, 10 mm to 100 mm, or 100 mm to 1000 mm.

In the light shielding article shown in FIG. 1, an optional substrate 14 is attached to at least a portion of a second major surface 25 of the first multilayer optical film 20. Such a substrate 14 can be directly attached or at least one intermediate layer 12 can be positioned between the substrate 14 and the first multilayer optical film 20 such that the substrate 14 is indirectly attached. Suitable intermediate layers 12 include for instance and without limitation, tie layers, organic base coat layers, barrier layers, or any combination thereof. In some preferred embodiments, an intermediate layer 12 is an adhesive (e.g., tie) layer. For instance, an adhesive 12 may be disposed on at least a portion of the second major surface 25 of the first multilayer optical film 20 or an adhesive disposed on at least a portion of the substrate 14 opposite the first multilayer optical film 20, or both. As shown in FIG. 1, an adhesive 12, an adhesive 16, and a substrate 14 disposed between the two adhesives are present.

In a second aspect, another light shielding article is provided. The light shielding article comprises: a) a first multilayer optical film comprised of at least a plurality of alternating first and second polymeric optical layers collectively reflecting at an incident light angle of at least one of 0°, 15°, 30°, 45°, 60°, or 75°, an average of at least 70, 80, 90, or 95 percent of incident visible light over at least a wavelength range from 400 nanometers (nm) to 700 nm, the multilayer optical film having a first major surface; and

b) a barrier coating disposed on the first major surface of the multilayer optical film, the barrier coating comprising: at least one dyad comprised of a (co)polymer layer overlaying the first major surface of the multilayer optical film and an inorganic layer overlaying the (co)polymer layer; and an outer (co)polymer layer overlaying the at least one dyad; and optionally, at least one outer inorganic layer overlaying the outer (co)polymer layer,

wherein the light shielding article transmits at an incident light angle of at least one of 0, 15°, 30°, 45°, 60°, or 75°, an average of at least 70, 80, 90, or 95 percent of incident radio frequency waves in at least one wavelength range from 1 mm to 10 mm, 10 mm to 100 mm, or 100 mm to 1000 mm, and wherein the light shielding article transmits, at an incident light angle of at least one of 0°, 15°, 30°, 45°, 60°, or 75°, an average of at most 50, 60, or 70 percent of incident ultraviolet light over at least a 30-nanometer wavelength reflection bandwidth in a wavelength range from 190 nm to 400 nm.

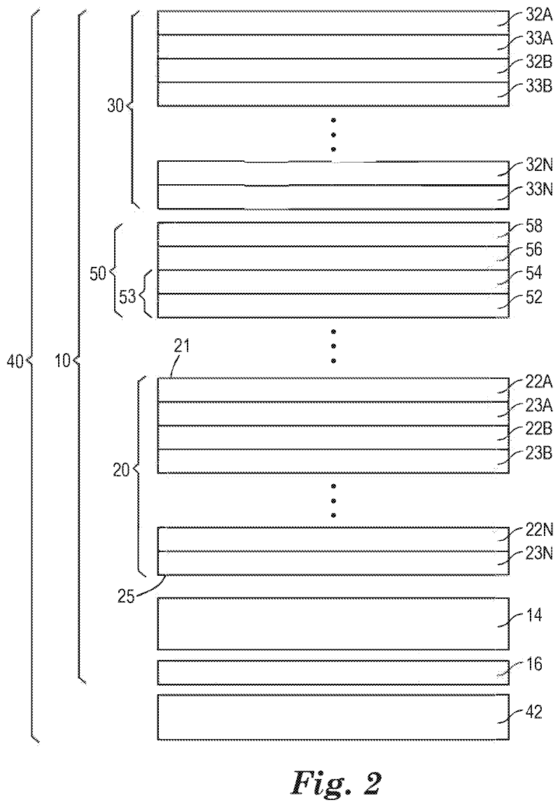

Referring now to FIG. 2, the present disclosure describes light shielding articles 10 including a first multilayer optical film 20 and a barrier coating 50 disposed on a first major surface 21 of the first multilayer optical film 20. The first multilayer optical film 20 is comprised of at least a plurality of alternating first polymeric optical layers 23 (A-N) and second polymeric optical layers 22 (A-N) collectively reflecting at an incident light angle of at least one of 0°, 15°, 30°, 45°, 60°, or 75°, an average of at least 70, 80, 90, or 95 percent of incident visible light over at least a wavelength range from 400 nanometers (nm) to 700 nm. The barrier coating 50 comprises at least one dyad 53 comprised of a (co)polymer layer 52 overlaying the first major surface 21 of the multilayer optical film 20 and an inorganic layer 54 overlaying the (co)polymer layer 52. The barrier coating 50 further includes an outer (co)polymer layer 56 overlaying the at least one dyad 53 and optionally, at least one outer inorganic layer 58 overlaying the outer (co)polymer layer 56. As used in the context of the barrier coating, “outer” refers to being the outermost of a specific type of layer in the barrier coating (e.g., outer (co)polymer layer or outer inorganic layer), not an outermost layer of the light shielding article as a whole.

In the embodiment depicted in FIG. 2, the light shielding article further includes a second multilayer optical film 30 disposed on the barrier coating 50 (e.g., on the outer (co)polymer layer 56 or on the optional outer inorganic layer 58 overlaying the outer (co)polymer layer 56. The second multilayer optical film 30 is comprised of at least a plurality of alternating first inorganic optical layers 33 (A-N) and second inorganic optical layers 32 (A-N) collectively reflecting and absorbing at an incident light angle of at least one of 0°, 15°, 30°, 45°, 60°, or 75°, an average of at least 50, 60, 70, 80, 90, or 95 percent of incident ultraviolet light over at least a 30-nanometer wavelength reflection bandwidth in a wavelength range from 190 nm to 400 nm.

In the light shielding article shown in FIG. 2, an optional substrate 14 is attached to at least a portion of a second major surface 25 of the first multilayer optical film 20. Additionally, as shown in FIG. 2, an optional adhesive 16 is disposed on at least a portion of the substrate 14 opposite the first multilayer optical film 20.

Advantageously, in many cases the light shielding article exhibits an atomic oxygen degradation, when tested according to the Atomic Oxygen Degradation Test, of less than 1×10⁻²⁰ mg/atom, 1×10⁻²¹ mg/atom, or 1×10⁻²² mg/atom. Such resistance to degradation by atomic oxygen is particularly useful when the light shielding article is part of a low earth orbit device.

Light shielding articles according to at least certain embodiments of the present disclosure also desirably exhibit low moisture transmission through the article, for instance preferably exhibiting a water vapor transmission rate (WVTR) of at most 5×10⁻³ or at most 5×10⁻⁵ g/m²/day at conditions of a temperature of 50° C. and 100% relative humidity (RH). The WVTR can be measured with a PERMATRAN 700 instrument from AMETEK MOCON (Brooklyn Park, MN) when exhibiting a rate of about 5×10⁻³ g/m²/day. The WVTR can be measured with a AQUATRAN 2 instrument from AMETEK MOCON when exhibiting a rate of about 5×10⁻⁵ g/m²/day.

Additionally, light shielding articles described herein may exhibit desirable levels of dielectric loss and/or dielectric constant.

Light shielding articles according to certain preferred embodiments of the present disclosure exhibit an average reflectance of wavelengths between 400 nm and 700 nm through the article being reduced by less than 20%, 10%, 5%, or less than 1% after exposure to a certain dose of ultraviolet light (e.g., in units of Joules per square centimeter (J/cm²)), such as the doses mentioned in the Examples below.

### First Multilayer Optical Film

Referring again to each of FIGS. 1 and 2, the light shielding article 10 includes a first multilayer optical film 20 comprising at least a plurality of alternating first polymeric optical layers 23 (A-N) and second polymeric optical layers 22 (A-N) as described further below.

Typically, the first multilayer optical film has a thickness of 2.0 micrometers or greater, 2.5 micrometers, 3.0 micrometers, 3.5 micrometers, 4.0 micrometers, 5.0 micrometers, or 5.5 micrometers or greater; and 1000 micrometers or less, 950 micrometers, 900 micrometers, 850 micrometers, 800 micrometers, 750 micrometers, or 700 micrometers or less, such as a thickness of 2 micrometers to 1000 micrometers.

In some cases, the plurality of alternating first and second polymeric optical layers collectively reflect at an incident light angle of at least one of 0°, 15°, 30°, 45°, 60°, or 75°, an average of at least 60, 70, 80, 90, or 95 percent of incident visible light over at least a 30-nanometer wavelength reflection bandwidth in a wavelength range from 400 nm to 700 nm, 400 nm to 500 nm, 450 nm to 550 nm, 600 nm to 700 nm, or any combination thereof.

Optionally, the plurality of alternating first and second polymeric optical layers collectively reflect at an incident light angle of at least one of 0°, 15°, 30°, 45°, 60°, or 75°, an average of at least 60, 70, 80, 90, or 95 percent of incident visible light over a greater wavelength reflection bandwidth than at least 30-nanometer, for instance at least a 50-nanometer, 75-nanometer, 100-nanometer, 125-nanometer, 150-nanometer, or 175-nanometer wavelength reflection bandwidth in a wavelength range from 400 nm to 700 nm.

In some cases, the plurality of alternating first and second polymeric optical layers collectively reflect at an incident light angle of at least one of 0°, 15°, 30°, 45°, 60°, or 75°, an average of at least 70, 80, 90, or 95 percent of incident infrared light over at least a 30-nanometer wavelength reflection bandwidth in a wavelength range from 700 nm to 1600 nm and/or 700 nm to 2000 nm.

The use of multilayer reflective films comprising alternating layers of two or more polymers to reflect light is known and is described, for example, in U.S. Pat. No. 3,711,176 (Alfrey, Jr. et al.), U.S. Pat. No. 5,103,337 (Schrenk et al.), WO 96/19347 (Jonza et al.), and WO 95/17303 (Ouderkirk et al.). The reflection and transmission spectra of a particular multilayer film depends primarily on the optical thickness of the individual layers, which is defined as the product of the actual thickness of a layer times its refractive index. Accordingly, films can be designed to reflect infrared, visible, or ultraviolet wavelengths λ_{M} of light by choice of the appropriate optical thickness of the layers in accordance with the following formula:

$${λ}_{M} = ( 2 / M ) * {D}_{r}$$

wherein M is an integer representing the particular order of the reflected light and Dᵣ is the optical thickness of an optical repeating unit (also called a multilayer stack) comprising two or more polymeric layers. Accordingly, Dᵣ is the sum of the optical thicknesses of the individual polymer layers that make up the optical repeating unit. Dᵣ is always one half lambda (λ) in thickness, where lambda is the wavelength of the first order reflection peak. By varying the optical thickness of an optical repeating unit along the thickness of the multilayer film, a multilayer film can be designed that reflects light over a broad band of wavelengths. This band is commonly referred to as the reflection band or stop band. In some embodiments, a reflection band has a sharp spectral edge at the long wavelength (red) and/or short wavelength (blue) side. It may be desirable to design a reflective film or other optical body that reflects light over a selected range in the visible region of the spectrum, e.g., a reflective film that reflects only green light. In such a case, it may be desirable to have sharp edges at both the red and blue sides of the reflection band. Multilayer optical films exhibiting sharpened reflective bandage(s) are described in detail, for instance, in U.S. Pat. No. 6,967,778 (Wheatley et al.), incorporated herein by reference in its entirety.

In one embodiment, an optical polymer film or a layered optical polymer film having a first and second major surface is provided. “Film” is used to refer to planar forms of plastic that are thick enough to be self-supporting but thin enough to be flexed, folded, conformed or creased without cracking. Film thickness depends upon desired applications and manufacturing methods.

“Optical Film” is used herein to refer to any reflective or partially reflective polymer film designed to exhibit desired reflection, transmission, absorption, or refraction of light upon exposure to a specific band of wavelengths of electromagnetic energy. Thus, conventional normally transparent polymeric films, such as polyester and polypropylene, are not considered “optical films” for the purposes of the present disclosure, even though such films may exhibit some degree of reflectance, or glare, when viewed from some angles. Films that exhibit both reflective and transmissive properties, however, such as those that are partially transmissive, are considered within the scope of this disclosure. Preferred optical polymer films generally absorb less than 25 percent of the radiant energy that impacts the film's surface. Preferably, the radiating energy absorbed is less than 10 percent and most preferably less than 5 percent. The radiant energy, typically expressed as the energy in a range of wavelengths, may be reflected either specularly or diffusely. The reflectance may be isotropic, i.e., the film has the same reflective properties along both in-plane axes, or may be anisotropic, i.e., the film has different reflective properties along the orthogonal in-plane axes. The difference in reflective properties along the in-plane axes can be varied by controlling the relationship between the indices of refraction along each axis for each of the component materials.

Optical films come in a variety of forms and are selected according to a desired application. Some suitable examples include multilayer polarizers, visible and infrared mirrors, and color films such as those described in Patent Publications WO 95/17303, WO 96/19347, and WO 97/01440; U.S. Pat. No. 6,045,894 (Jonza et al.) U.S. Pat. No. 6,531,230 (Weber et al.); U.S. Pat. No. 5,103,337 (Schrenk et al.), U.S. Pat. No. 5,122,905 (Wheatley et al.), U.S. Pat. No. 5,122,906 (Wheatley), U.S. Pat. No. 5,126,880 (Wheatley et al.), U.S. Pat. No. 5,217,794 (Schrenk), U.S. Pat. No. 5,233,465 (Schrenk et al.), U.S. Pat. No. 5,262,894 (Wheatley et al.), U.S. Pat. No. 5,278,694 (Wheatley et al.), U.S. Pat. No. 5,339,198 (Wheatley et al.), U.S. Pat. No. 5,360,659 (Arends et al.), U.S. Pat. No. 5,448,404 (Schrenk et al.), U.S. Pat. No. 5,486,949 (Schrenk et al.) U.S. Pat. No. 4,162,343 (Wilcox et al.), U.S. Pat. No. 5,089,318 (Shetty et al.), U.S. Pat. No. 5,154,765 (Armanini), and U.S. Pat. No. 3,711,176 (Alfrey, Jr. et al.); and Reissued U.S. Pat. No. RE 31,780 (Cooper et al.) and U.S. Pat. No. RE 34,605 (Schrenk et al.), all contents of which are incorporated herein by reference.

Examples of optical films comprising immiscible blends of two or more polymeric materials include blend constructions wherein the reflective and transmissive properties are obtained from the presence of discontinuous polymeric regions having a cross-sectional diameter perpendicular to the major axis that is on the order of a fraction of the distance corresponding to a wavelength of light, and may also obtain the desired optical properties through orientation, such as the blend mirrors and polarizers as described in Patent Publications WO 97/32224 (Ouderkirk et al.), U.S. Pat. No. 6,179,948 (Merrill et al.), and U.S. Pat. No. 5,751,388 (Larson), the contents of which are all herein incorporated by reference. Additional suitable reflective films include the reflective cube-corner sheeting described in U.S. Pat. No. 5,450,235 (Smith et al.), U.S. Pat. No. 5,691,846 (Benson et al.), U.S. Pat. No. 5,614,286 (Bacon, et al.) and U.S. Pat. No. 5,763,049 (Frey et al.), all of whose descriptions are incorporated herein by reference. Examples of these films are available commercially, for example from 3M Company as 3M SCOTCHLITE Reflective Material Series 6200 High Gloss Film and as SCOTCHLITE Diamond Grade Ultraflexible Conspicuity Sheeting Series 960. These optical films achieve optical properties through the presence of cured cube-corner structures on one side of a polymer film construction.

Optionally, a micro-voided film may be employed as an optical film. “Micro-voided” means having internal discrete voids having an average void diameter of 50 to 10,000 nm, which may be spherical, oblate, or some other shape. Exemplary polymers useful for forming a microvoided polymer film include polyethylene terephthalate (PET) available from 3M Company. Modified PET copolyesters including PETG available, for example, as SPECTAR 14471 and EASTAR GN071 from Eastman Chemical Company, Kingsport, TN, and PCTG available, for example, as TIGLAZE ST and EB0062 also from Eastman Chemical Company are also useful high refractive index polymers. The molecular orientation of PET and PET modified copolyesters may be increased by stretching, which increases its in-plane refractive indices providing even more reflectivity in the multilayer optical film. In general, an incompatible polymer additive, or inorganic particle additive, is blended into the PET host polymer at levels of at least 10 wt. %, at least 20 wt. %, at least 30 wt. %, at least 40 wt. %, or even at least 49 wt. % during extrusion prior to stretching to nucleate voids during the stretching process. Suitable incompatible polymer additives for PET include: fluoropolymers, polypropylenes, polyethylenes, and other polymers which do not adhere well to PET. Similarly, if polypropylene is the host polymer, then incompatible polymer additives such as PET or fluoropolymers can be added to the polypropylene host polymer at levels of at least 10 wt. %, at least 20 wt. %, at least 30 wt. %, at least 40 wt. %, or even at least 49 wt. % during extrusion prior to stretching to nucleate voids during the stretching process. Exemplary suitable inorganic particle additives for nucleating voids in micro-voided polymer films include titania, silicon oxide, aluminum oxide, aluminum silicate, zirconia, calcium carbonate, barium sulfate, and glass beads and hollow glass bubbles, although other inorganic particles and combinations of inorganic particles may also be used. Crosslinked polymeric microspheres can also be used instead of inorganic particles. Preferably, the polymeric particles comprise particles of an aromatic polyester. Inorganic particles can be added to the host polymer at levels of at least 10 wt. %, at least 20 wt. %, at least 30 wt. %, at least 40 wt. %, or even at least 49 wt. % during extrusion prior to stretching to nucleate voids during the stretching process. If present, the inorganic particles preferably have a volume average particle diameter of 5 nm to 1 micrometer, although other particle sizes may also be used.

In some embodiments, the polymeric optical layers of the first multilayer optical film comprise a fluoropolymer, a polyethylene terephthalate (PET), a polymethyl methacrylate (PMMA), a polypropylene (PP) copolymer, a polyethylene (PE) copolymer, a copolymer of ethyl acrylate and methyl methacrylate (CoPMMA), a blend of PMMA and polyvinylidene fluoride (PVDF), an acrylate copolymer, a polyurethane, a polyethylene naphthalate (PEN), or combinations thereof.

When the first multilayer optical film comprises a fluoropolymer, the polymeric optical layers preferably comprise a fluoropolymer independently selected from the group consisting of a copolymer of tetrafluoroethylene (TFE), hexafluoropropylene (HFP), and vinylidene fluoride; a copolymer of TFE, HFP, vinylidene fluoride, and perfluoropropyl vinyl ether (PPVE); a polyvinylidene fluoride (PVDF); an ethylene chlorotrifluoroethylene (ECTFE) polymer; an ethylene tetrafluoroethylene (ETFE); a perfluoroalkoxy alkane (PFA) polymer; a fluorinated ethylene propylene (FEP) polymer; a polytetrafluoroethylene (PTFE); a copolymer of TFE, HFP, and ethylene; a polyvinyl fluoride (PVF); and combinations thereof.

Referring back to each of FIGS. 1 and 2, the first multilayer optical film 20 includes a multilayer optical stack having alternating layers 22, 23 of at least two materials, typically comprising different polymers. An in-plane index of refraction n1 in one in-plane direction of high refractive index layer 23 is higher than the in-plane index of refraction n2 of low refractive index layer 22 in the same in-plane direction. The difference in refractive index at each boundary between layers 22, 23 causes part of the incident light to be reflected. The transmission and reflection characteristics of the first multilayer optical film 20 is based on coherent interference of light caused by the refractive index difference between layers 22, 23 and the thicknesses of layers 22, 23. When the effective indices of refraction (or in-plane indices of refraction for normal incidence) differ between layers 22, 23, the interface between adjacent layers 22, 23 forms a reflecting surface. The reflective power of the reflecting surface depends on the square of the difference between the effective indexes of refraction of the layers 22, 23 (e.g., (n1-n2)²). By increasing the difference in the indices of refraction between the layers 22, 23, improved optical power (higher reflectivity), thinner films (thinner or fewer layers), and broader bandwidth performance can be achieved. The refractive index difference in one in-plane direction in an exemplary embodiment is at least about 0.05, preferably greater than about 0.10, more preferably greater than about 0.15 and even more preferably greater than about 0.20.

In some embodiments, the materials of layers 22, 23 inherently have differing indices of refraction. In another embodiment, at least one of the materials of the layers 22, 23 has the property of stress induced birefringence, such that the index of refraction (n) of the material is affected by the stretching process. By stretching the first multilayer optical film 20 over a range of uniaxial to biaxial orientations, films can be created with a range of reflectivities for differently oriented plane-polarized incident light.

The number of layers in the first multilayer optical film 20 is selected to achieve the desired optical properties using the minimum number of layers for reasons of film thickness, flexibility and economy. In the case of reflective films such as mirrors, the number of layers is preferably less than about 2,000, more preferably less than about 1,000, and even more preferably less than about 750. In some embodiments, the number of layers is at least 150 or 200. In other embodiments, the number of layers is at least 250.

The first multilayer optical film comprises multiple low/high index pairs of film layers, wherein each low/high index pair of layers 22, 23 has a combined optical thickness of ½ the center wavelength of the band it is designed to reflect. Stacks of such films are commonly referred to as quarter-wave stacks. In some embodiments, different low/high index pairs of layers may have different combined optical thicknesses, such as where a broadband reflective optical film is desired.

The various constituent layers of first multilayer optical film, whether as skin layers or optical layers, may be resistant to ultraviolet radiation. Many fluoropolymers are resistant to UVradiation. Examples of fluoropolymers that may be used include copolymers of tetrafluoroethylene (TFE), hexafluoropropylene (HFP), and vinylidene fluoride (e.g., available from 3M Company under the trade designation 3M DYNEON THV); a copolymer of TFE, HFP, vinylidene fluoride, and perfluoropropyl vinyl ether (PPVE) (e.g., available from 3M Company under the trade designation 3M DYNEON THVP); a polyvinylidene fluoride (PVDF) (e.g., 3M DYNEON PVDF 6008 from 3M Company); ethylene chlorotrifluoroethylene polymer (ECTFE) (e.g., available as HALAR 350LC ECTFE from Solvay, Brussels, Belgium); an ethylene tetrafluoroethylene copolymer (ETFE) (e.g., available as 3M DYNEON ETFE 6235 from 3M Company); perfluoroalkoxyalkane polymers (PFA); fluorinated ethylene propylene copolymer (FEP); a polytetrafluoroethylene (PTFE); copolymers of TFE, HFP, and ethylene (HTE) (e.g., available as 3M DYNEON HTE1705 from 3M Company). Combinations of fluoropolymers can also be used. In some embodiments, the fluoropolymer includes FEP. In some embodiments, the fluoropolymer includes PFA. In some embodiments, the fluoropolymer includes PVF.

Examples of non-fluorinated polymers that may be used in at least one layer of the first multilayer optical film include at least one of: PET, polypropylene copolymers, polyethylene copolymers, polyethylene methacrylate copolymers, polymethyl methacrylate, methyl methacrylate copolymers (e.g., copolymers of ethyl acrylate and methyl methacrylate), polyurethanes, acrylate copolymers, extended chain polyethylene polymers (ECPEs), polyethylene naphthalate (PEN), or a combinations thereof. In general, combinations of non-fluorinated polymers can be used. Exemplary nonfluorinated polymers, especially for use in high refractive index optical layers, may include homopolymers of polymethyl methacrylate (PMMA), such as those available as CP71 and CP80 from Ineos Acrylics, Inc., Wilmington, DE; and polyethyl methacrylate (PEMA), which has a lower glass transition temperature than PMMA. Suitable polyethylene naphthalate (PEN) polymers are available under the tradename “Teonex Q51” from DuPont Teijin, Chester, VA. Additional useful polymers include: copolymers of methyl methacrylate such as, for example, a copolymer made from 75 wt. % methyl methacrylate and 25 wt. % ethyl acrylate, for example, as available from Ineos Acrylics, Inc. as PERSPEX CP63, or as available from Arkema, Philadelphia, PA as ALTUGLAS 510, and copolymers of methyl methacrylate monomer units and n-butyl methacrylate monomer units. Blends of PMMA and PVDF may also be used.

Suitable triblock acrylic copolymers are available, for example, as KURARITY LA4285 from Kuraray America Inc., Houston, TX. Additional suitable polymers for the optical layers, especially for use in the refractive index optical layers, may include at least one of: polyolefin copolymers such as poly(ethylene-co-octene) (e.g., available as ENGAGE 8200 from Dow Elastomers, Midland, MI), polyethylene methacrylate (e.g., available as ELVALOY from Dow Elastomers), poly (propylene-co-ethylene) (e.g., available as Z9470 from Atofina Petrochemicals, Inc., Houston, TX); and a copolymer of atactic polypropylene and isotactic polypropylene. Materials may be selected based on absorbance or transmittance properties described herein, as well as on refractive index. In general, the greater the refractive index between two materials, the thinner the film can be, which may be desirable for efficient heat transfer.

Multilayer optical films can be made by coextrusion of alternating polymer layers having different refractive indices, for example, as described in U.S. Pat. No. 5,882,774 (Jonza et al.); U.S. Pat. No. 6,045,894 (Jonza et al.); U.S. Pat. No. 6,368,699 (Gilbert et al.); U.S. Pat. No. 6,531,230 (Weber et al.); U.S. Pat. No. 6,667,095 (Wheatley et al.); U.S. Pat. No. 6,783,349 (Neavin et al.); U.S. Pat. No. 7,271,951 B2 (Weber et al); U.S. Pat. No. 7,632,568 (Padiyath et al.); U.S. Pat. No. 7,652,736 (Padiyath et al.); and U.S. Pat. No. 7,952,805 (McGurran et al.); and PCT Publications WO 95/17303 (Ouderkirk et al.) and WO 99/39224 (Ouderkirk et al.).

Typically, the first multilayer optical film has an average thickness of 50 micrometers to 250 micrometers, such as 50 micrometers or greater, 55 micrometers, 60 micrometers, 65 micrometers, 70 micrometers, 75 micrometers, 80 micrometers, 85 micrometers, 90 micrometers or 95 micrometers or greater; and 250 micrometers or less, 225 micrometers, 200 micrometers, 175 micrometers, 150 micrometers, 125 micrometers, 100 micrometers, 90 micrometers, 80 micrometers, 70 micrometers, or 60 micrometers or less.

### Second Multilayer Optical Film

Referring again to FIG. 1, the light shielding article 10 includes a second multilayer optical film 30 comprising at least a plurality of alternating first inorganic optical layers 33 (A-N) and second inorganic optical layers 32 (A-N) as described further below.

Typically, the second multilayer optical film has a thickness of 200 nm or greater, 250 nm, 300 nm, 350 nm, 400 nm, 500 nm, or 550 nm or greater; and 900 nm or less, 850 nm, 800 nm, 750 nm, 700 nm, 650 nm, or 600 nm or less, such as a thickness of 200 nm to 900 nm.

In some cases, the plurality of alternating first and second inorganic optical layers collectively reflect and absorb at an incident light angle of at least one of 0°, 15°, 30°, 45°, 60°, or 75°, an average of at least 60, 70, 80, 90, or 95 percent of incident ultraviolet light over at least a 30-nanometer wavelength reflection bandwidth in a wavelength range from 190 nm to 240 nm, 240 nm to 300 nm, 300 nm to 350 nm, 350 nm to 400 nm, or any combination thereof.

Optionally, the plurality of alternating first and second inorganic optical layers collectively reflect and absorb at an incident light angle of at least one of 0°, 15°, 30°, 45°, 60°, or 75°, an average of at least 60, 70, 80, 90, or 95 percent of incident ultraviolet light over a greater wavelength reflection bandwidth than at least 30-nanometer, for instance at least a 50-nanometer, 75-nanometer, 100-nanometer, 125-nanometer, 150-nanometer, or 175-nanometer wavelength reflection bandwidth in a wavelength range from 190 nm to 400 nm.

As the plurality of alternating first and second inorganic optical layers collectively reflect and absorb, some portion of the incident ultraviolet light may be absorbed and some portion reflected. In some cases, the alternating first and second inorganic optical layers collectively absorb at an incident light angle of at least one of 0°, 15°, 30°, 45°, 60°, or 75°, an average of at least 30, 40, 50, 60, 70, 80, 90, or 95 percent of incident light over at least a 30-nanometer wavelength bandwidth in a wavelength range from 190 nm to less than 350 nm. In some cases, the alternating first and second inorganic optical layers collectively reflect at an incident light angle of at least one of 0°, 15°, 30°, 45°, 60°, or 75°, an average of at least 30, 40, 50, 60, 70, 80, 90, or 95 percent of incident light over at least a 30-nanometer wavelength bandwidth in a wavelength range from 190 nm to less than 400 nm, 190 nm to 240 nm, 240 nm to 300 nm, 300 nm to 350 nm, 350 nm to less than 400 nm, or any combination thereof.

In select embodiments of the light shielding article, the alternating first and second inorganic optical layers collectively transmit at an incident light angle of at least one of 0°, 15°, 30°, 45°, 60°, or 75°, an average of at least 50, 60, 70, 80, 90, or 95 percent of incident visible light in a wavelength range from greater than 400 nm to 700 nm.

### Inorganic Layers

In some cases, the first optical layer comprises at least one of niobium oxide, titanium oxide, silicon oxynitride, molybdenum oxide, tungsten oxide, silicon nitride, indium tin oxide, hafnium oxide, tantalum oxide, zirconium oxynitride, zirconium oxide, aluminum zinc oxide, or zinc oxide. Alloys of oxides may be suitable, as known to those skilled in the art. In some cases, the second optical layer comprises at least one of silicon oxide, aluminum oxide, aluminum fluoride, magnesium fluoride, calcium fluoride, indium tin oxide, or zinc oxide. In select embodiments, the first optical layer comprises at least one of niobium oxide or titanium oxide, and the second optical layer comprises silicon oxide. When a photoactive inorganic material such as titanium oxide is employed, typically a non-photoactive material (e.g., silicon oxide, aluminum oxide, etc.) may be disposed between the photoactive inorganic material and any organic layers to minimize degradation of the organic layer. For instance, referring again to FIG. 1, a layer of a non-photoactive material could be an intermediate layer (not shown) located between the first optical layer 33N and the first major surface 21 of the first multilayer optical film 20.

Optical thin film stack designs comprised of alternating thin layers of inorganic dielectric materials with refractive index contrast, are particularly suited for the multilayer optical film. In recent decades they have been used for applications in UV, Visible, NIR and IR spectral regions. Depending upon the spectral region of interest, there are specific materials suitable for that region. Also, for coating these materials, one of two forms of physical vapor deposition (PVD) are used: evaporation or sputtering. Evaporated coatings rely upon heating the coating material (evaporant) to a temperature at which it evaporates. This is followed by condensation of the vapor upon a substrate. For evaporated dielectric mirror coatings, the electron-beam deposition process is most commonly used. Sputtered coatings use energetic gas ions to bombard a material (“target”) surface, ejecting atoms which then condense on the nearby substrate. Depending upon which coating method is used, and the settings used for that method, thin film coating rate and structure-property relationships will be strongly influenced. Ideally, coating rates should be high enough to allow acceptable process throughput and film performance, characterized as dense, low stress, void free, non-optically absorbing coated layers. One skilled in the art could extend such deposition techniques to include CVD, ALD, and other vapor depositions.

The number of optical layers is selected to achieve the desired optical properties using the minimum number of layers for reasons of film thickness, flexibility and economy. Typically, the total number of layers is preferably 21 or less, 19, 17, 15, or 13 optical layers or less; and 3 optical layers or more, 5, 7, 9, or 11 optical layers or more, may be needed.

The thickness of each of the first and second optical layers can vary substantially. For instance, in some cases each of the first optical layers and each of the second optical layers independently has a thickness of 5 nm or greater, 10 nm, 15 nm, 20 nm, 25 nm, 30 nm, 35 nm, 40 nm, 45 nm, 50 nm, 55 nm, 60 nm, 65 nm, or 70 nm or greater; and a thickness of 200 nm nm or less, 150 nm, 145 nm, 140 nm, 135 nm, 130 nm, 125 nm, 120 nm, 115 nm, 110 nm, 105 nm, 100 nm, 95 nm, 90 nm, 85 nm, 80 nm, or 75 nm or less.

Multilayer optical films described herein can be made using general processing techniques, such as those described in U.S. Pat. No. 6,783,349 (Neavin et al.), the entire disclosure of which is incorporated herein by reference in its entirety.

Dielectric mirrors, with optical thin film stack designs comprised of alternating thin layers of inorganic dielectric materials with refractive index contrast, have been used for applications in UV, Visible, NIR and IR spectral regions in recent decades. Depending upon the spectral region of interest there are specific materials suitable for that region. Also, for coating these materials, one of two forms of physical vapor deposition (PVD) are used: evaporation or sputtering. Evaporated coatings rely upon heating the coating material (evaporant) to a temperature at which it evaporates. This is followed by condensation of the vapor upon a substrate. For evaporated dielectric mirror coatings, the electron-beam deposition process is most commonly used.

Sputtered coatings use energetic gas ions to bombard a material (“target”) surface, ejecting atoms which then condense on the nearby substrate. Depending upon which coating method is used, and the settings used for that method, thin film coating rate and structure-property relationships will be strongly influenced. Ideally, coating rates should be high enough to allow acceptable process throughput and film performance, characterized as dense, low stress, void free, non-optically absorbing coated layers.

For manufacturing inorganic coatings, the electron beam process is best suited for coating discrete parts. Optionally, light shielding articles can be prepared in continuous roll-to-roll (R2R) fashion for larger articles. Though some chambers have demonstrated R2R film coating, the layer by layer coating sequence would still be necessary. For R2R sputtering of inorganic layers of light shielding articles 10, it is advantageous to use a sputtering system with multiple sources located around one, or perhaps two, coating drums. Here, for a thirteen layers optical stack design, a two, or even single, machine pass process, with alternating high and low refractive index layers coated sequentially, would be feasible. How many machine passes needed would be contingent upon machine design, cost, practicality of thirteen consecutive sources, and the like. Additionally, coating rates would need to be matched to a single film line speed.

The film roll transport initially starts at a pre-determined speed, and the sputter source power is ramped to full operating power, followed by introduction of the reactive gases and then achieving steady state condition. Depending upon the length of film to coat, the process continues until total footage is achieved. Here, as the sputter source is orthogonal to and wider than the film which is being coated, the uniformity of coating thickness is quite high. Upon reaching the desired length of coated film the reactive gases are set to zero and the target is sputtered to a pure metal surface state. The film direction is next reversed and a rotary pair of sputter targets has AC frequency (40 kHz) power applied in an argon sputtering atmosphere. Upon reaching steady state, oxygen reactive gas is introduced to provide transparency and low refractive index. At the predetermined process setting and line speed the second layer is coated over the length which was coated for layer one. Again, as these sputter sources are also orthogonal to and wider than the film being coated, the uniformity of coating thickness is quite high. After reaching the desired length of coated film the reactive oxygen is removed and the target is sputtered in argon to a pure metal surface state. Layers three to five (or seven or nine, eleven or thirteen, etc.) depending upon optical targets, are coated in this sequence. Optionally, some layers are deposited in multiple machine passes, for instance to limit thermal load. Upon completion, the film roll is removed for post-processing.

The Examples describe in more detail exemplary processes to make exemplary light shielding articles 10.

### Barrier Coatings

Referring to FIG. 2, the barrier coatings 50 comprise at least one dyad 53 positioned on the first multilayer optical film 20 as described further below. Preferably, the barrier coatings comprise a plurality of dyads 53, optionally wherein the plurality of dyads 53 is at least or exactly two dyads, three dyads, four dyads, five dyads, or six dyads.

Barrier coatings of at least certain embodiments of the present disclosure can exhibit superior mechanical properties such as elasticity and flexibility yet still have low atomic oxygen degradation rates. The coatings have at least one dyad comprising a (co)polymer layer and an oxide layer and can have additional inorganic or hybrid organic/inorganic layers. In one embodiment, the barrier coatings can have alternating (co)polymer layers and oxide layers. In other exemplary embodiments, the disclosed barrier coatings can include one or more hybrid organic/inorganic layers.

Each (co)polymer layer in the at least one dyad and the outer (co)polymer layer comprises a (co)polymer selected from an olefinic (co)polymer, a (meth)acrylate (co)polymer, a urethane (co)polymer, a fluoropolymer, a silicone (co)polymer, or a combination thereof.

(Co)polymeric layers can be formed from a variety of organic materials or compounds using a variety of processes. The (co)polymeric layer may be crosslinked in situ after it is applied. In one embodiment, the (co)polymeric layer can be formed by flash evaporation, vapor deposition and (co)polymerization of a monomer using, for example, heat, plasma, UV radiation or an electron beam.

Exemplary monomers for use in such a method include volatilizable (meth)acrylate monomers. In a specific embodiment, volatilizable acrylate monomers are employed. Suitable (meth)acrylates will have a molecular weight that is sufficiently low to allow flash evaporation and sufficiently high to permit condensation on the substrate. The organic materials or compounds also can be vaporized using any methods like those described below for vaporizing a metal alkoxide.

If desired, the (co)polymeric layers can alternatively be applied using conventional methods such as plasma deposition, solution coating, extrusion coating, roll coating (e.g., gravure roll coating), or spray coating (e.g., electrostatic spray coating), and if desired crosslinked or (co)polymerized, (e.g., as described above. The desired chemical composition and thickness of the additional layer will depend in part on the nature and desired purpose of the light shielding article. Coating efficiency can be improved by cooling the article.

Exemplary organic compounds include esters, vinyl compounds, alcohols, carboxylic acids, acid anhydrides, acyl halides, thiols, amines and mixtures thereof. Non-limiting examples of esters include (meth)acrylates, which can be used alone or in combination with other multifunctional or monofunctional (meth)acrylates. Exemplary (meth)acrylates include hexanediol diacrylate, ethoxyethyl acrylate, phenoxyethyl acrylate, cyanoethyl (mono)acrylate, isobornyl acrylate, octadecyl acrylate, isodecyl acrylate, lauryl acrylate, beta-carboxyethyl acrylate, tetrahydrofurfuryl acrylate, dinitrile acrylate, pentafluorophenyl acrylate, nitrophenyl acrylate, 2-phenoxyethyl acrylate, 2,2,2-trifluoromethyl acrylate, diethylene glycol diacrylate, triethylene glycol diacrylate, tripropylene glycol diacrylate, tetraethylene glycol diacrylate, neopentyl glycol diacrylate, propoxylated neopentyl glycol diacrylate, polyethylene glycol diacrylate, tetraethylene glycol diacrylate, bisphenol A epoxy diacrylate, trimethylol propane triacrylate, ethoxylated trimethylol propane triacrylate, propylated trimethylol propane triacrylate, tris(2-hydroxyethyl)-isocyanurate triacrylate, pentaerythritol triacrylate, phenylthioethyl acrylate, naphthloxyethyl acrylate, IRR-214 cyclic diacrylate from UCB Chemicals, epoxy acrylate RDX80095 from Rad-Cure Corporation, the corresponding methacrylates of the acrylates listed above and mixtures thereof. Exemplary vinyl compounds include vinyl ethers, styrene, vinyl naphthylene and acrylonitrile. Exemplary alcohols include hexanediol, naphthalenediol and hydroxyethylmethacrylate. Exemplary carboxylic acids include phthalic acid and terephthalic acid, (meth)acrylic acid). Exemplary acid anhydrides include phthalic anhydride and glutaric anhydride. Exemplary acyl halides include hexanedioyl dichloride, and succinyl dichloride. Exemplary thiols include ethyleneglycol-bisthioglycolate, and phenylthioethylacrylate. Exemplary amines include ethylene diamine and hexane 1,6-diamine.

Optionally, at least one (co)polymer layer in the at least one dyad or the outer (co)polymer layer further comprises an ultraviolet radiation absorber, a hindered amine light stabilizer, an antioxidant, or a combination thereof. UV absorbers (UVAs), Hindered Amine Light Stabilizers (HALs), and antioxidants can help prevention of photo-oxidation degradation of the (co)polymer layer. Suitable compounds include benzophenones, benzotriazoles, and triazines (e.g., benzotriazines). Exemplary UVAs for incorporation into the (co)polymer layer include those available under the trade designations “TINUVIN 1577” and “TINUVIN 1600,” from BASF Corporation, Florham Park, NJ. U.S. Pat. No. 9,670,300 (Olson et al.) and U.S. Pat. App. Pub. No. 2017/0198129 (Olson et al.) describe exemplary UVA oligomers that are compatible with PVDF fluoropolymers. Exemplary HALs for incorporation into the hard coat layer include those available under the trade designations “CHIMMASORB 944” and “TINUVIN 123,” from BASF Corporation. Typically, UVAs, HALs, and/or antioxidants are incorporated in the (co)polymer layer at a concentration of 1-10 wt. %.

Each of the inorganic layers in the at least one dyad and the optional at least one outer inorganic layer 58 overlaying the outer (co)polymer layer comprises an inorganic material selected from silicon oxide, silica alumina oxide, silicon oxynitride, gallium oxide, magnesium oxide, niobium oxide, titanium dioxide, yttrium oxide, zinc oxide, tin oxide, nickel oxide, tungsten oxide, aluminum doped zinc oxide, indium tin oxide, zirconium oxide, zirconium oxynitride, hafnia, aluminum oxide, alumina doped silicon oxide, lanthanum fluoride, neodymium fluoride, aluminum fluoride, magnesium fluoride, calcium fluoride, or a combination thereof.

An outer (co)polymer layer 56 overlays the at least one dyad 53, which may be a plurality of dyads 53 as mentioned above. The outer (co)polymer layer 56 is preferably crosslinked.

In some exemplary embodiments, the outer (co)polymer layer comprises an olefinic (co)polymer selected from low density polyethylene, linear low density polyethylene, ethylene vinyl acetate, polyethylene methyl acrylate, polyethylene octene, polyethylene propylene, polyethylene butene, polyethylene maleic anhydride, polymethyl pentene, polyisobutene, polyisobutylene, polyethylene propylene diene, cyclic olefin (co)polymers, and blends thereof.

In certain exemplary embodiments, the at least one (co)polymer layer in the at least one dyad or the outer (co)polymer layer further comprises an ultraviolet radiation absorber, a hindered amine light stabilizer, an antioxidant, or a combination thereof.

The ultraviolet radiation absorber is preferably selected from a benzotriazole compound, a benzophenone compound, a triazine compound, or a combination thereof. Presently preferred hindered amine light stabilizers are available from BASF U.S.A (Florham Park, NJ) under the trade name “TINUVIN”. The hindered amine light stabilizer is preferably selected from TINUVIN 123, TINUVIN 144, TINUVIN 292, or a combination thereof. Presently preferred antioxidants are available from BASF under the trade name “IRGANOX” and “IRGAFOS”. Suitable antioxidants for polyolefins are preferably selected from IRGANOX 1010, IRGANOX 1076, IRGAFOS 168, or a combination thereof.

The barrier coatings can be subjected to various post-treatments such as heat treatment, UV or vacuum UV (VUV) treatment, or plasma treatment. Heat treatment can be conducted by passing the barrier coating through an oven or directly heating the barrier coating in the coating apparatus, (e.g., using infrared heaters or heating directly on a drum. Heat treatment may for example be performed at temperatures from about 30° C. to about 200° C., about 35° C. to about 150° C., or about 40° C. to about 70° C.

### Substrates

As mentioned above, a substrate is an optional component in light shielding articles according to the present disclosure. In some cases, a polymeric substrate may be used. An advantage to employing a polymeric substrate is avoiding the high cost of working with glass, which may be rigid and/or small in surface area. Additionally, in some embodiments according to the present disclosure flexible substrates are used in roll-to-roll processing of manufacturing the light shielding article. In some cases, the substrate (or the light shielding article) has an area of at least 50 square centimeters, such as at least 60, 70, 80, 90, or at least 100 square centimeters.

In any of the foregoing embodiments, the substrate 14 may be comprised of or consist of a polymeric material, such as a (co)polymer. In some exemplary embodiments, the substrate comprises polyethylene terephthalate (PET), a crosslinked polysiloxane, a silicone thermoplastic polymer, a crosslinked urethane, a thermoplastic urethane, a crosslinked (meth)acrylate, PMMA, coPMMA, a polyimide, a cyclic olefin copolymer, a cyclic olefin polymer, a polycarbonate, PEN, or a fluoropolymer (co)polymer comprising polymerized units derived from one or more monomers selected from tetrafluoroethylene, hexafluoropropylene, vinylidene fluoride, a perfluoroalkoxy alkylene a vinyl fluoride, or a combination thereof.

Suitable polyimide substrates are available under the trade name “KAPTON” from E. I. DuPont de Nemours, Wilmington, DE, of which “KAPTON CS100” is currently preferred. Suitable PMMA polymers include those available as CP71 and CP80 from Ineos Acrylics, Inc., Wilmington, DE. One suitable polycarbonate substrate is available under the trade name “Makrofol”, from Bayer AG (Darmstadt, Germany). Suitable methyl methacrylate copolymers (CoPMMA) include, for instance, a CoPMMA made from 75 wt. % methylmethacrylate (MMA) monomers and 25 wt. % ethyl acrylate (EA) monomers, (available, for example, from Ineos Acrylics, Inc. (London, England) under the trade designation “PERSPEX CP63” or Arkema Corp., (Philadelphia, PA) under the trade designation “ATOGLAS 510”), a CoPMMA formed with MMA comonomer units and n-butyl methacrylate (nBMA) comonomer units, or a blend of PMMA and poly(vinylidene fluoride) (PVDF). Suitable polyethylene naphthalate (PEN) polymers are available under the tradename “Teonex Q51” from DuPont Teijin, Chester, VA.

In certain exemplary embodiments, the fluorinated (co)polymer preferably comprises tetrafluoroethylene, hexafluoropropylene, vinylidene fluoride, a perfluoroalkoxy alkane, or a combination thereof. Suitable fluoropolymer substrates are available under the trade name “TEFLON FEP100” from E. I. DuPont de Nemours, Wilmington, DE, or which “TEFLON FEP100 500A is currently preferred. Suitable exemplary fluoropolymers also include copolymers of tetrafluorethylene, hexafluoropropylene, and vinylidene fluoride (THV) under the trade designations “DYNEON THV 220,” “DYNEON THV 221,” “DYNEON THV 230,” “DYNEON THV 2030,” “DYNEON THV 415”, “DYNEON THV 500”, “DYNEON THV 610”, and “DYNEON TIV 815” from Dyneon LLC, Oakdale, MN.

The smoothness and adhesion of layers to the substrate can be enhanced by appropriate optional pretreatment of the substrate or optional application of a priming layer. Methods for surface modification are known in the art. In one embodiment, a pretreatment regimen involves electrical discharge pretreatment of the substrate in the presence of a reactive or non-reactive atmosphere (e.g., plasma, glow discharge, corona discharge, dielectric barrier discharge or atmospheric pressure discharge), chemical pretreatment, or flame pretreatment. These pretreatments can help ensure that the surface of the substrate will be receptive to the subsequently applied layers. In one embodiment, the method can include plasma pretreatment. For organic surfaces, plasma pretreatments can include nitrogen or water vapor. Another pretreatment regimen involves coating the substrate with an inorganic or organic base coat layer optionally followed by further pretreatment using plasma or one of the other pretreatments described above.

Preferably, the substrate transmits an average of at least 70, 80, 90, or 95 percent of incident visible light in a wavelength range from greater than 400 nm to 700 nm.

### Optional Transparent Adhesive Tie Layer

Suitable transparent adhesives for one or more tie layers (e.g., intermediate layer 12 and/or adhesive 16) include for instance, pressure sensitive adhesives. Classes of suitable pressure sensitive adhesives include acrylics, tackified rubber, tackified synthetic rubber, ethylene vinyl acetate, silicones, and the like. Suitable acrylic adhesives are disclosed, for example, in U.S. Pat. No. 3,239,478 (Harlan); U.S. Pat. No. 3,935,338 (Robertson); U.S. Pat. No. 5,169,727 (Boardman); U.S. Pat. No. 4,952,650 (Young et al.) and U.S. Pat. No. 4,181,752 (Martens et al.), incorporated herein by reference.

In select embodiments, the transparent adhesive is optically clear, which means that the adhesive has both transparency and clarity (e.g., low haze). In certain embodiments, an optically clear adhesive (OCA) is selected from an acrylate, a polyurethane, a polyolefin (such as a polyisobutylene (PIB)), a silicone, or a combination thereof. Illustrative OCAs include those described in International Pub. No. WO 2008/128073 (Everaerts et al.) relating to antistatic optically clear pressure sensitive adhesives, U.S. Pat. App. Pub. Nos. US 2009/089137 (Sherman et al.) relating to stretch releasing OCA, US 2009/0087629 (Everaerts et al.) relating to indium tin oxide compatible OCA, US 2010/0028564 (Cheng et al.) relating to antistatic optical constructions having optically transmissive adhesive, US 2010/0040842 (Everaerts et al.) relating to adhesives compatible with corrosion sensitive layers, US 2011/0126968 (Dolezal et al.) relating to optically clear stretch release adhesive tape, and U.S. Pat. No. 8,557,378 (Yamanaka et al.) relating to stretch release adhesive tapes. Suitable OCAs include acrylic optically clear pressure sensitive adhesives such as, for example, 3M OCA 8146, 8211, 8212, 8213, 8214, and 8215, each available from 3M Company, St. Paul, MN.

In some embodiments, the transparent adhesive may be resistant to ultraviolet radiation damage. Exemplary adhesives which are typically resistant to ultraviolet radiation damage include silicone adhesives and acrylic adhesives containing UV-stabilizing/blocking additive(s), for example. U.S. Pat. No. 5,504,134 (Palmer et al.), for instance, describes attenuation of polymer substrate degradation due to ultraviolet radiation through the use of metal oxide particles in a size range of about 0.001 to about 0.2 micrometers (in some embodiments, about 0.01 micrometers to about 0.15 micrometers) in diameter. U.S. Pat. No. 5,876,688 (Laundon), describes a method for producing micronized zinc oxide that are small enough to be transparent when incorporated as UV blocking and/or scattering agents in paints, coatings, finishes, plastic articles, cosmetics and the like which are well suited for use in the present invention. These fine particles such as zinc oxide and titanium oxide with particle sizes ranging from 10 nm to 100 nm that can attenuate UV radiation are available, for example, from Kobo Products, Inc., South Plainfield, NJ.

### Electromagnetic Receivers and Emitters

In a third aspect, an electromagnetic receiver and/or emitter is provided. The electromagnetic receiver and/or emitter includes a light shielding article according to any embodiments of the first aspect and second aspect described in detail above.

Some examples of electromagnetic receivers, electromagnetic emitters (and both receivers and emitters) include for instance and without limitation, satellites, cube-sats, nanosatellites, microsatellites, minisatellites, small satellites, medium satellites, intermediate satellites, large satellites, heavy satellites, extra heavy satellites, telescopes, antennas, antenna arrays, photosensors, drones, space vehicles, and space habitations.

Light shielding articles according to the present disclosure may thus be used to protect one or more of such electromagnetic receivers and/or emitters by being applied to a major surface (e.g., an exterior surface exposed to high altitude environments). The light shielding articles shield at least some of the incident wavelengths in the visible and ultraviolet ranges while allowing the transmission of at least some wavelengths in the radio frequency range.

Referring again to FIG. 1, the present disclosure describes an electromagnetic receiver and/or emitter 40 including a light shielding article 10 attached to at least a portion 42 of the electromagnetic receiver and/or emitter. The light shielding article 10 includes a first multilayer optical film 20 and a second multilayer optical film 30 disposed on a first major surface 21 of the first multilayer optical film 20.

Referring again to FIG. 2, the present disclosure describes an electromagnetic receiver and/or emitter 40 including a light shielding article 10 attached to at least a portion 42 of the electromagnetic receiver and/or emitter. The light shielding article 10 includes a first multilayer optical film 20 and a barrier coating 50 disposed on a first major surface 21 of the first multilayer optical film 20, as well as an optional second multilayer optical film 30 disposed on the barrier coating 50.

### Listing of Exemplary Embodiments

In a first embodiment is provided a light shielding article. The light shielding article includes a) a first multilayer optical film comprised of at least a plurality of alternating first and second polymeric optical layers collectively reflecting at an incident light angle of at least one of 0°, 15°, 30°, 45°, 60°, or 75°, an average of at least 70, 80, 90, or 95 percent of incident visible light over at least a wavelength range from 400 nanometers (nm) to 700 nm, the multilayer optical film having a first major surface; and b) a second multilayer optical film disposed on the first multilayer optical film, the second multilayer optical film comprised of at least a plurality of alternating first and second inorganic optical layers collectively reflecting and absorbing at an incident light angle of at least one of 0°, 15°, 30°, 45°, 60°, or 75°, an average of at least 50, 60, 70, 80, 90, or 95 percent of incident ultraviolet light over at least a 30-nanometer wavelength reflection bandwidth in a wavelength range from 190 nm to 400 nm. The light shielding article transmits at an incident light angle of at least one of 0°, 15°, 30°, 45°, 60°, or 75°, an average of at least 70, 80, 90, or 95 percent of incident radio frequency waves in at least one wavelength range from 1 millimeter (mm) to 10 mm, 10 mm to 100 mm, or 100 mm to 1000 mm.

In a second embodiment is provided another light shielding article. The light shielding article includes a) a first multilayer optical film comprised of at least a plurality of alternating first and second polymeric optical layers collectively reflecting at an incident light angle of at least one of 0°, 15°, 30°, 45°, 60°, or 75°, an average of at least 70, 80, 90, or 95 percent of incident visible light over at least a wavelength range from 400 nanometers (nm) to 700 nm, the multilayer optical film having a first major surface; and b) a barrier coating disposed on the first major surface of the multilayer optical film. The barrier coating includes at least one dyad comprised of a (co)polymer layer overlaying the first major surface of the multilayer optical film and an inorganic layer overlaying the (co)polymer layer; and an outer (co)polymer layer overlaying the at least one dyad; and optionally, at least one outer inorganic layer overlaying the outer (co)polymer layer. The light shielding article transmits at an incident light angle of at least one of 0°, 15°, 30°, 45°, 60°, or 75°, an average of at least 70, 80, 90, or 95 percent of incident radio frequency waves in at least one wavelength range from 1 mm to 10 mm, 10 mm to 100 mm, or 100 mm to 1000 mm. The light shielding article transmits, at an incident light angle of at least one of 0°, 15°, 30°, 45°, 60°, or 75°, an average of at most 50, 60, or 70 percent of incident ultraviolet light over at least a 30-nanometer wavelength reflection bandwidth in a wavelength range from 190 nm to 400 nm.

In a third embodiment is provided a light shielding article according to the second embodiment, further comprising a second multilayer optical film disposed on the barrier coating, the second multilayer optical film comprised of at least a plurality of alternating first and second inorganic optical layers collectively reflecting and absorbing at an incident light angle of at least one of 0°, 15°, 30°, 45°, 60°, or 75°, an average of at least 50, 60, 70, 80, 90, or 95 percent of incident ultraviolet light over at least a 30-nanometer wavelength reflection bandwidth in a wavelength range from 190 nm to 400 nm.

In a fourth embodiment is provided a light shielding article according to the second embodiment or the third embodiment, wherein the at least one dyad is a plurality of dyads, optionally wherein the plurality of dyads is two dyads, three dyads, four dyads, five dyads, or six dyads.

In a fifth embodiment is provided a light shielding article according to any of the second through fourth embodiments, wherein the at least one inorganic layer is formed of an inorganic material selected from silicon oxide, silica alumina oxide, silicon oxynitride, gallium oxide, magnesium oxide, niobium oxide, titanium dioxide, yttrium oxide, zinc oxide, tin oxide, nickel oxide, tungsten oxide, aluminum doped zinc oxide, indium tin oxide, zirconium oxide, zirconium oxynitride, hafnia, aluminum oxide, alumina doped silicon oxide, lanthanum fluoride, neodymium fluoride, aluminum fluoride, magnesium fluoride, calcium fluoride, or a combination thereof.

In a sixth embodiment is provided a light shielding article according to any of the second through fifth embodiments, wherein each (co)polymer layer in the at least one dyad comprises a (co)polymer selected from an olefinic (co)polymer, a (meth)acrylate (co)polymer, a urethane (co)polymer, a fluoropolymer, a silicone (co)polymer, or a combination thereof.

In a seventh embodiment is provided a light shielding article according to any of the second through sixth embodiments, wherein the article exhibits an atomic oxygen degradation, when tested according to the Atomic Oxygen Degradation Test, of less than 1×10⁻²⁰ mg/atom, 1×10⁻²⁰ mg/atom, or 1×10⁻²² mg/atom.

In an eighth embodiment is provided a light shielding article according to any of the first through seventh embodiments, wherein the polymeric optical layers of the first multilayer optical film comprise a fluoropolymer, a polyethylene terephthalate (PET), CoPMMA, a polypropylene (PP) copolymer, a polyethylene copolymer, PMMA, a blend of PMMA and polyvinylidene fluoride (PVDF), an acrylate copolymer, a polyurethane, PEN, or combinations thereof.

In a ninth embodiment is provided a light shielding article according to any of the first through eighth embodiments, wherein the polymeric optical layers of the first multilayer optical film comprise a fluoropolymer independently selected from the group consisting of a copolymer of tetrafluoroethylene (TFE), hexafluoropropylene (HFP), and vinylidene fluoride; a copolymer of TFE, HFP, vinylidene fluoride, and perfluoropropyl vinyl ether (PPVE); a polyvinylidene fluoride (PVDF); an ethylene chlorotrifluoroethylene (ECTFE) polymer; an ethylene tetrafluoroethylene (ETFE); a perfluoroalkoxy alkane (PFA) polymer; a fluorinated ethylene propylene (FEP) polymer; a polytetrafluoroethylene (PTFE); a copolymer of TFE, HFP, and ethylene; a polyvinyl fluoride (PVF); and combinations thereof.

In a tenth embodiment is provided a light shielding article according to any of the first or third through ninth embodiments, wherein the first optical layer of the second multilayer optical film comprises at least one of niobium oxide, titanium oxide, silicon oxynitride, molybdenum oxide, tungsten oxide, silicon nitride, indium tin oxide, hafnium oxide, tantalum oxide, zirconium oxynitride, zirconium oxide, aluminum zinc oxide, or zinc oxide and wherein the second optical layer comprises at least one of silicon oxide, aluminum oxide, aluminum fluoride, magnesium fluoride, calcium fluoride, indium tin oxide, aluminum zinc oxide, or zinc oxide.

In an eleventh embodiment is provided a light shielding article according to any of the first or third through tenth embodiments, wherein the second multilayer optical film is present and the first optical layer of the second multilayer optical film comprises at least one of niobium oxide or titanium oxide, and wherein the second optical layer comprises silicon oxide.

In a twelfth embodiment is provided a light shielding article according to any of the first or third through eleventh embodiments, wherein the second multilayer optical film is present and has a thickness of 200 nm to 900 nm.

In a thirteenth embodiment is provided a light shielding article according to any of the first or third through twelfth embodiments, wherein the second multilayer optical film is present and each of the first and second optical layers of the second multilayer optical film independently has a thickness of 5 nm to 200 nm.

In a fourteenth embodiment is provided a light shielding article according to any of the first or third through thirteenth embodiments, wherein the second multilayer optical film is present and is formed of 3 to 21 total first and second optical layers.

In a fifteenth embodiment is provided a light shielding article according to any of the first or third through fourteenth embodiments, wherein the second multilayer optical film is present and the plurality of alternating first and second inorganic optical layers of the second multilayer optical film collectively reflect and absorb at an incident light angle of at least one of 0°, 15°, 30°, 45°, 60°, or 75°, an average of at least 60, 70, 80, 90, or 95 percent of incident ultraviolet light over at least a 50-nanometer, 75-nanometer, 100-nanometer, 125-nanometer, 150-nanometer, or 175-nanometer wavelength reflection bandwidth in a wavelength range from 190 nm to 400 nm.

In a sixteenth embodiment is provided a light shielding article according to any of the first through fifteenth embodiments, further comprising a substrate attached to at least a portion of a second major surface of the first multilayer optical film.

In a seventeenth embodiment is provided a light shielding article according to any of the first through sixteenth embodiments, further comprising an adhesive disposed on at least a portion of the second major surface of the first multilayer optical film or disposed on at least a portion of the substrate opposite the first multilayer optical film, or both.

In an eighteenth embodiment is provided a light shielding article according to any of the first through seventeenth embodiments, exhibiting a water vapor transmission rate (WVTR) of at most 5×10⁻³ or at most 5×10⁻⁵ g/m²/day at 50° C., 100% relative humidity (RH).

In a nineteenth embodiment is provided a light shielding article according to any of the first through eighteenth embodiments, wherein at least one (co)polymer layer in the at least one dyad or the outer (co)polymer layer further comprises an ultraviolet radiation absorber, a hindered amine light stabilizer, an antioxidant, or a combination thereof.

In a twentieth embodiment is provided a light shielding article according to the nineteenth embodiments, wherein the ultraviolet radiation absorber is selected from a benzotriazole compound, a benzophenone compound, a triazine compound, or a combination thereof.

In a twenty-first embodiment is provided a light shielding article according to any of the first through twentieth embodiments, wherein the plurality of alternating first and second polymeric optical layers collectively reflect at an incident light angle of at least one of 0°, 15°, 30°, 45°, 60°, or 75°, an average of at least 70, 80, 90, or 95 percent of incident infrared light over at least a 30-nanometer wavelength reflection bandwidth in a wavelength range from 700 nm to 1600 nm and/or 700 nm to 2000 nm.

In a twenty-second embodiment is provided a light shielding article according to any of the first through twenty-first embodiments, exhibiting a desirable composite dielectric loss.

In a twenty-third embodiment is provided a light shielding article according to any of the first through twenty-second embodiments, exhibiting a desirable composite dielectric constant.

In a twenty-fourth embodiment is provided a light shielding article according to any of the first through twenty-third embodiments, exhibiting an average reflectance of wavelengths between 400 nm and 700 nm through the article that is reduced by less than 20%, 10%, 5%, or less than 1% after exposure to a certain dose of ultraviolet light.

In a twenty-fifth embodiment is provided an electromagnetic receiver and/or emitter. The electromagnetic receiver and/or emitter includes the light shielding article according to any of the first through twenty-fourth embodiments attached to at least a portion of the electromagnetic receiver and/or emitter.

### Examples

Unless otherwise noted or readily apparent from the context, all parts, percentages, ratios, etc. in the Examples and the rest of the specification are by weight.

Materials Used in the Examples

| Abbreviation | Description and Source |
|---|---|
| PET | Polyethylene terephthalate substrate |
| | film, obtained under tradename |
| | “Melinex ST504” from DuPont Teijin |
| | Films; Chester, VA |
| PET carrier | 0.127 mm-thick × 366 mm-wide |
| | Polyethylene terephthalate film, |
| | obtained under the trade designation |
| | “XST 6642” from E. I. DuPont de |
| | Nemours; Wilmington, DE |
| DF2000F | Visible light reflector film obtained |
| | under tradename “DF2000F” from |
| | 3M Company; St Paul, MN |
| FEP | Fluorinated ethylene propylene (FEP) |
| | substrate film, obtained under trade |
| | name “TEFLON FEP100 500A” |
| | from E. I. DuPont de Nemours; |
| | Wilmington, DE |
| TiO₂ | TiO₂ source material was purchased |
| | under trade name “Titanium Oxide |
| | tablets, TiO₂, 99.9% pure” from Kurt |
| | J Lesker Company; Jefferson Hills, |
| | PA |
| SiO₂ | SiO₂ source material was purchased |
| | under trade name “Silicon Oxide |
| | Pieces, SiO₂, 99.99% pure” from |
| | Kurt J Lesker Company; Jefferson |
| | Hills, PA |
| SiOx:B | SiOx:B layer sputter deposited from |
| | a boron doped silicon (Si:B) |
| | sputtering target obtained from |
| | Materion Corporation; Mayfield Heights, |
| | OH |
| Al | Aluminum wire was obtained under |
| | tradename “1100 Aluminum wire” |
| | from Phifer Wire Products; Tuscaloosa, AL |
| Cr | Chromium flakes obtained under |
| | tradename “Cr Flakes, 99.999%” from |
| | Vacuum Engineering and Materials; |
| | Santa Clara, CA |
| PMMA | UV absorber masterbatch in |
| UVA MB | polymethylmethacrylate obtained under |
| | tradename “TA11-10 MB03” from |
| | Sukano Polymers Corporation; |
| | Dunkin SC |
| CoPMMA | Co-polyethylmethylmethacrylate |
| | resin obtained under tradename |
| | “LA4285” from Kuraray America, |
| | Inc.; Houston, TX |
| PP | Polypropylene resin obtained under |
| | the tradename “Pro-fax SR549M” |
| | from LyondellBasell; Houston, TX |
| SR833S | Tricyclodecane dimethanol diacrylate |
| | monomer, obtained under the trade |
| | designation “SR833S” from Sartomer |
| | USA, Exton, PA |
| Silicon chip | Silicon wafers cut into 0.75” × 0.75” |
| | (1.91 cm × 1.91 cm) pieces, |
| | obtained under part number “452” |
| | from University Wafer Inc; South |
| | Boston, MA |
| Kapton HN | 2 mil thick Kapton HN film obtained |
| | under the trade designation |
| | “KAPTON HN” from E. I. DuPont de |
| | Nemours, Wilmington, DE |

### Test Methods

Spectral Properties Measurement Test: The spectral transmission and reflection were measured using a spectrophotometer (obtained under the trade designation “LAMBDA 1050” from PerkinElmer, Inc., Waltham, MA). The coated surfaces of the examples faced the light source during measurement, except for Comparative Example 3, which had the PET substrate facing the light source, and Comparative Example 4, which had the formerly premasked side facing the light source. Measured spectral reflectance and transmission are reported as an average percent over a wavelength range in the Reflection and Absorption Results Table and Transmission Results Table. The measured reflection for the first multilayer optical film used in many of the examples and comparative examples, DF2000F, is also reported in the First Multilayer Optical Film Reflectance Measurement Table.

Spectral Properties Modeling Test: Because the substrate can impact the UV spectral properties of measured films, especially the transmission and absorption in the case of UV absorbing substrates like DF2000F, the reflection, transmission, and absorption of the UV absorbing and reflecting coatings (Examples 1, 3, and 4, and Comparative Example 1) were modeled to better estimate the UV reflection and absorption of the UV absorbing and reflecting coatings. To perform this modeling, Test Samples 1, 2, and 3 were measured with an ellipsometer (obtained under tradename “RC2 Ellipsometer” from J. A. Woolam; Lincoln, NE) to determine the spectral index of refraction (n) and extinction coefficient (k) values of the evaporated TiO₂, SiO₂, and SR833 materials. Then the n and k obtained above were inputted into optical modeling software (obtained under tradename “Essential MaCleod” from The Thin Film Center; Tucson, AZ) and used to compute the reflection, transmission, and absorption spectra for the multilayer optical films prepared as described below. All structures were modeled with a PET substrate. Note that this stage of modeling only calculates the transmission, reflection, and absorption of the coatings (e.g., SiO₂, TiO₂, or SR833 layers); the modeling does not calculate the absorption or reflection of the polymer films (e.g., FEP) or substrate material (e.g., DF2000F).

For the samples Example 3 and Example 4 where additional polymer films were included in the layers of the samples, the absorption contribution by these polymer films was determined in the following manner: the modeled transmission of the optical coatings (obtained as described in the preceding paragraph) was multiplied by the absorption spectrum of FEP (obtained by measuring an uncoated film of FEP with the Spectral Properties Measurement Test above) and divided by 100 (to maintain units of %) to calculate the absorption of the FEP film. Then, in the case of Example 3, the calculated absorption of the FEP was subtracted from the modeled transmission, and the remaining transmission value was multiplied by the absorption spectrum of an uncoated film of Preparatory Example 3 (obtained by measuring an uncoated film of 1 mil 50:50 PMMA UVA MB:CoPMMA with the Spectral Properties Measurement Test above) and divided by 100 (to maintain units of %) to calculate the absorption of the Preparatory Example 3 film. For Example 3, the sum of the absorption contributions from the FEP and Preparatory Example 3 films was added to the modeled absorption values to obtain the final modeled absorption spectrum. For Example 4, only the absorption of FEP was added to the modeled absorption to obtain the final modeled absorption spectrum.

In the case of Comparative Example 1, the UV absorbing coating on the substrate does not fully block the UV wavelengths of light below 400 nm where the absorption and reflection by DF2000F substrates can be significant. In this case, some light is absorbed and reflected by the DF2000F substrate in addition to the absorption that occurs in the coatings, and the measured absorption and reflection therefore includes contributions from both the DF2000F substrate and the coatings, whereas the purpose of the test is to assess the absorption of only the coatings. To account for the impact of the substrate, the absorption and reflection contribution of the DF2000F substrate was estimated by multiplying the modeled transmission of the coatings (see Spectral Properties Modeling Test section below) by the measured absorption and reflection of an uncoated DF2000F substrate, and dividing this product by 100 (to maintain units of %). These are reported as the Modeled DF2000F A (%) and Modeled DF2000F R (%) in the Reflection and Absorption Results Table. These modeled DF2000F absorption and reflection spectra were then subtracted from the measured absorption and reflection spectra respectively of Comparative Example 1 to calculate a more accurate representation of the measured absorption and reflection of the coatings, which is reported as the Corrected Measured A (%) and Corrected Measured R (%) in the Reflection and Absorption Results Table.

The results of the reflection, absorption, and transmission modeling are reported as an average percent over a wavelength range in the Reflection and Absorption Results Table and Transmission Results Table.

Solar Aging Test: Samples were exposed in an Atlas Ci5000 Weather-Ometer (obtained from AMETEK, Berwyn, PA), using a xenon arc lamp equipped with quartz inner and outer filters. The quartz filter set provides minimal attenuation to the spectral power distribution of the xenon lamp, which gives a close approximation to the shape of solar output (ASTM E490). To increase the rate at which dosage is accumulated, the samples were exposed on custom-made stainless steel and aluminum extended holders. The extended holders move the exposure plane from 19 inches (48.3 cm) away from the core of the lamp to 13.5 inches (34.3 cm) from the core of the lamp. Irradiance was controlled at 1.5 W/m² at 340 nm at the rack plane and was measured to be 2.6 W/m² at 340 nm at the extended sample plane. Ambient air temperature inside the Weatherometer was controlled at 48° C., a black-panel thermometer (BPT) was controlled at 75° C. at the rack plane and measured to be approximately 95° C. at the sample plane, and relative humidity was controlled at 30%. Samples were exposed without any backing. Samples were exposed to a dose of 425 megajoules per square meter (MJ/m²) and 850 MJ/m² cumulative irradiance from 250-385 nm. The samples were oriented so their coated surfaces were facing the light source, except for Comparative Example 3, which had the PET substrate facing the light source, and Comparative Example 4, which had the formerly premasked side of the DF2000F facing the light source.

The change in reflection was calculated as

$$\% reduction in reflection = \frac{{R}_{Fresh} - {R}_{Aged}}{{R}_{Fresh}}$$

where R_{fresh} is the average reflection from 400-700 nm before solar aging, and R_{aged} is the average reflection from 400-700 nm after the above exposure. The results of the Solar Aging Test are summarized in the Solar Aging Results Table.

Radio Frequency Transmission Test: Radio Frequency transmission was directly measured at 27 GHz and 78 GHZ using a free space measurement system; designed and built by Thomas Keating Ltd (Billingshurst, United Kingdom), called the Quasi-Optical Measurement System. The Quasi-Optical system was combined with a Keysight Vector Network Analyzer (VNA) (obtained from Keysight Technologies, Santa Rosa, CA). The transmission and reflection were directly measured as complex scattering parameters (S-parameters). Magnitude of the S-parameter transmission coefficient (S12) was reported at 11.1 mm (27 GHz) at 3 angles of incidence, 0 degrees, 30 degrees, and 60 degrees, and at 3.8 mm (78 GHz) at 2 angles of incidence, 0 degrees and 30 degrees.

The Quasi-Optical Measurement System used 2 corrugated horn antennas and 4 mirrors to focus a Gaussian beam. An electromagnetic signal from the VNA, in the frequency band of 22-33 GHz and 60-90 GHz, was sent through the corrugated horn antenna at port 1, where the Gaussian beam was then focused by 2 mirrors, then passed through the sample holder, the beam was then again focused between 2 more mirrors and received at the second corrugated horn and sent back to the VNA at port 2. The sample holder, at the center of the Quasi-Optical System, could be rotated on an axis to measure transmission & reflection at multiple angles of incidence, from 0 degrees to 60 degrees.

Atomic Oxygen Degradation Test: The test specimens, and Kapton HN film specimens to be used as test witnesses, were cut as 1.5″×1.5″ (3.81 cm×3.81 cm) squares. Before being weighed, they were placed into a vacuum oven (oven obtained under tradename “VWR 1410D” from Avantor; Radnor, PA) evacuated using a vacuum pump (obtained under tradename “Rocker 400 Vacuum Pump” from Sterlitech Corporation; Auburn, WA) and held at 80° C. and −70 kPa for at least 12 hours to dehydrate them before measuring their mass. Then they were weighed on a high precision balance capable of measuring mass to 0.1 mg (obtained under the trade designation “PRACTUM64-1S” from Sartorius Corporation, Bohemia, NY). The test specimens and witnesses were then placed on a glass plate ¼″ (0.635 cm) thick, then covered with a ⅛″ (0.3175 cm) glass masking plate with 1″ (2.54 cm) diameter circular holes cut from it. The masking plate was placed such that the test specimens and witnesses were centered underneath the circular holes. The assembly was then placed into a batch plasma system, on the powered electrode of the plasma reactor. The test specimens and witnesses were exposed to an oxygen plasma using a batch plasma reactor (obtained under the trade designation “PLASMA-THERM 3032” from Plasma Therm 5 LLC, St. Petersburg, FL). The instrument was configured for reactive ion etching with a 26″ (66.0 cm) lower powered electrode and central gas pumping. The chamber was pumped with a roots type blower (obtained under the trade designation “EH1200” from Edwards Engineering, Burgess Hill, UK) backed by a dry mechanical pump (obtained under the trade designation “iQDP80” from Edwards Engineering). The RF power was delivered by a 3 kW, 13.56 Mhz solid-state generator 10 (obtained under the trade designation “RFPP RF30S” from Advanced Energy Industries, Fort Collins, CO). The system had a nominal base pressure of 5 millitorr (0.67 Pa). The flow rates of the gases were controlled by MKS flow controllers (obtained from MKS Instruments, Andover, MA).

After pumping down to the base pressure, oxygen (O₂) was introduced at 500 standard 15 cubic cm/min (secm). Once the gas flow stabilized in the reactor, rf power (2000 watts) was applied to the electrode to generate the plasma. The samples were exposed to the ignited plasma for a total exposure time of 4 hours. This was typically performed in 4, 1-hour long exposures. Following completion of each plasma exposure, the chamber was vented to the atmosphere and the test specimens and witnesses were removed from the chamber. The mass of each test specimen and witness was measured again, and the change in mass was recorded. If additional exposure time was needed to complete the 4-hour exposure, the samples were placed back into the test fixture as per above, carefully centering them so they retained the same position under the apertures in the glass masking plate. New, unexposed pieces of KAPTON HN were used for each exposure, as it is sometimes observed that the KAPTON HN mass loss is non linear during prolonged or multiple exposures. After the samples were exposed for a total of 4 hours, the samples and witnesses were dehydrated again in the vacuum oven for 12 hours, and then their final mass measurement was taken. For each exposure, the effective atomic oxygen fluence (atoms) of the plasma treatment was determined by dividing the mass loss of the KAPTON HN witnesses for that exposure by the density of KAPTON HN (1.412 g/cm³) and by the atomic oxygen erosion yield of KAPTON HN (2.81×10⁻²⁴ cm³/atom). The total mass loss of the test specimens after 4 hours of exposure was then divided by the total effective atomic oxygen fluence to determine the mass loss per effective atomic oxygen atom (mg/atom). Thus, the atomic oxygen degradation is quantified as the mass loss per effective atomic oxygen atom (mg/atom).

### Preparatory Examples

Preparatory Example 1: Barrier films were prepared by covering FEP with a stack of a first polymer layer, an inorganic boron doped silicon oxide (SiOx: B) barrier layer, a second polymer layer, and a second SiOx: B layer, on a vacuum coater similar to the coater described in U.S. Pat. No. 5,440,446 (Shaw et al.) and U.S. Pat. No. 7,018,713 (Padiyath et al), both of which are incorporated herein by reference in their entireties. The individual layers were formed as follows:

Layer 1 (first polymer layer): A 350-meter long roll PET carrier film was loaded into a roll-to-roll vacuum processing chamber. Sheets of FEP substrate were taped to the PET carrier using a polyimide tape. The chamber was pumped down to a pressure of less than 1×10⁻⁵ Torr (1.3×10⁻³ Pa). A web speed of 2.5 meter/minute was held while maintaining the backside of the PET carrier film in contact with a coating drum chilled to −23° C.

With the PET carrier film backside in contact with the drum, the substrate frontside surface was treated with a nitrogen plasma at 0.15 kW of plasma power. The substrate frontside surface was then coated with SR833S. The monomer was degassed under vacuum to a pressure of 20 millitorr (2.67 Pa) prior to coating, loaded into a syringe pump (obtained from Harvard Apparatus; Holliston, MA) and pumped at a flow rate of 1.0 milliliter/minute through an ultrasonic atomizer (obtained under tradename MicroMist from Sono-Tek; Milton, NY) operating at a frequency of 60 kHz into a heated vaporization chamber maintained at 260° C.

The resulting monomer vapor stream condensed onto the film surface and was electron beam crosslinked using a multi-filament electron-beam cure gun (obtained from PCT Ebeam and Integration; Davenport, IA) operating at 7.0 kV and 4 mA to form a 750 nm-thick first polymer layer. Then the film web was advanced and the film and substrate were wound up in a film roll in order to expose additional samples for coating.

Layer 2 (inorganic layer): After the first polymer deposition and winding up of the film and substrate, without removing the film roll or substrate from the vacuum processing chamber, the film was unwound to bring the substrate back onto the chill roll and to bring the backside of the PET carrier film back into contact with the drum. Then a SiOx: B layer was reactive magnetron sputter-deposited onto the first polymer layer. One direct current (DC) power supply (obtained under tradename Pinnacle Plus 5 kW from Advanced Energy; Denver, CO) was used to control one cathode; with the cathode housing a Si: B sputtering target.

During sputter deposition a predetermined oxygen flow to the cathode was maintained manually. The pulsed DC power supply sputtered the Si: B target using 2800 watts of power at 175 kHz pulsing, and 1.5 microsecond duration, with a gas mixture containing 110 standard cubic centimeter per minute (secm) argon and 32 seem oxygen at a sputter pressure of 3.1 millitorr at a line speed of 7.2 feet/minute (2.19 meter/minute). This provided a 25 nm-thick SiOx: B layer deposited atop the first polymer layer of Layer 1.

Layer 3 (second polymer layer): Immediately after the SiOx: B layer deposition and with the backside of the PET carrier film still in contact with the drum, SR833S was condensed onto Layer 2 and crosslinked as described for Layer 1. This provided a 750 nm-thick second polymer layer atop Layer 2. Then the film web was advanced and the film and substrate were wound up in a film roll in order to expose additional samples for coating.

Preparatory example 2: Films of Preparatory Example 1 were coated with an additional inorganic layer (Layer 4): After the second polymer deposition and winding up of the film and substrate, without removing the film roll or substrate from the vacuum processing chamber, the film was unwound to bring the substrate back onto the chill roll and to bring the backside of the PET carrier film back into contact with the drum. Then a SiOx: B layer was reactive magnetron sputter-deposited onto the second polymer layer. One direct current (DC) power supply was used to control one cathode; with the cathode housing a Si: B sputtering target.

Preparatory Example 3: Multilayer films of PP and 50:50 weight:weight (PMMA UVA MB):CoPMMA were made using two twin screw extruders and a three layer multilayer film extrusion die. The films were extruded with an A/B/A structure, where the A layer was made from PP, and the B layer was made from 50:50 wt:wt (PMMA UVA MB):CoPMMA. The A layer was extruded with an 18 mm, twin-screw extruder (obtained under tradename “Micro-18” from Leistritz Advanced Technologies Corp.; Allendale, NJ) with an extruder final zone temperature of 250° C. and screw speed of 100 RPM. The B layer was extruded from an 18 mm, twin-screw extruder (obtained under tradename “Micro 18 Extruder” from Thermo Fisher Scientific; Waltham, MA) with an extruder final zone temperature of 250° C. and screw speed of 100 RPM. The melt streams were combined in a 3 layer A/B/A extrusion die, and the polymer melt was extrusion cast onto a chilled roll set to 50° C. and wound onto a 3″ (7.6 cm) diameter cardboard core. The speed of the wheel was tuned to obtain a final film with a 0.5 mil (12.7 micrometer) A layer thickness and a 1 mil (25.4 micrometer) B layer thickness. Then the PP skins were removed to leave a final film of only the 1 mil (25.4 micrometer) 50:50 wt:wt (PMMA UVA MB):CoPMMA.

Preparatory Example 4: A vapor coated multilayer optical film consisting of 5 pairs of alternating layers of 58.8 nm of SiO₂ and 36.1 nm of TiO₂ was prepared on a substrate of Preparatory Example 1 in the following manner: the vapor coater used was a Denton Vacuum Optical Coater consisting of a 5-planet planetary drive system located ˜30″ (76.2 cm) above a 4-pocket Temescal Electron Beam gun (obtained from Ferro Tec Corporation, Livermore, CA). The planetary drive system was designed to hold the substrate perpendicular to the evaporation source and to move that disk in a planetary type motion in and out of the evaporation plume during the deposition. The actual process for the coating consisted of: a) The vapor coater was vented to atmosphere and one the five planets was removed. The substrate was prepared for coating by adhering/taping it to the planet by a polyimide tape. The sample was oriented so the previously coated surface of Preparatory Example 1 was exposed for coating. b) The planet was reinstalled, and the other 4 planets were configured similarly, if needed, and they too were reinstalled in the coater. c) The chamber was closed and pumped to a vacuum level of <2×10⁻⁵ Torr (2.7×10⁻³ Pa). d) When the vapor coater was at a low enough vacuum, the material was ion beam treated using a Kaufman-type ion source for ˜10 minutes at a voltage of 400V as a pretreatment to the substrate for adhesion of the vapor deposited coating to the substrate prior to applying the oxide films. e) Oxygen gas was added via a MKS mass flow controller (obtained from MKS Instruments, Inc., Andover, MA) to obtain a pressure of 4.0×10⁻⁵ Torr (5.3×10⁻³ Pa). This was usually about 10 seems for added oxygen gas. f) The planetary drive system was started and moved around the coater at a rotational speed of ˜60 rpm to prepare for coating and to achieve a high level of uniformity on the attached substrates. g) A Temescal electron beam gun (e-gun) power supply was energized. A voltage of 10 kV and a current of a few milliamps was applied to the e-gun's filament, heating the source material in the e-gun. The source was heated and controlled via an Eddy Company Optical Monitoring System (OMS) (from Eddy Company, Apple Valley, CA). The source was heated until the desired deposition rate of the material was achieved; in the case of TiO₂ this rate was 2 angstroms per second (A/s), and in the case of SiO₂ this was 4 A/s. When the desired deposition rate of the material was achieved and steady, a shutter that separates the source from the planets was opened and the rate was maintained via the OMS until the desired optical thickness was achieved, at which point the shutter closed and the OMS shuts power off to the ebeam source. h) The main power to the power supply was turned off and the source allowed to cool for about 10 minutes. i) This process was repeated for additional layers/types of material until the full desired multilayer optical film had been deposited. j) The chamber was then vented back to atmospheric pressure via N₂ gas and each planet was removed and the substrate was removed from each planet.

The structure of Preparatory Example 4 is summarized in the Examples Structure Table below.

Preparatory Example 5: Films of Preparatory Example 2 were coated with 200 nm of TiO₂ on the previously coated side, using the same vapor coating method described in Preparatory Example 4.

### Test Samples

Test Sample 1: Test Sample 1 was prepared in the same manner as Preparatory Example 4 except a 70 nm thick TiO₂ layer was deposited on a silicon chip.

Test Sample 2: Test Sample 2 was prepared in the same manner as Preparatory Example 4 except a 115 nm thick SiO₂ layer was deposited on a silicon chip.

Test Sample 3: Test Sample 3 was prepared in the same manner as Preparatory Example 1, except a PET substrate was used, and only a single polymer layer of 750 nm of SR833 was deposited.

### Examples

Example 1: Example 1 was prepared in the same manner as Preparatory Example 4, except a substrate of DF2000F was used instead of a substrate of Preparatory Example 1. Prior to coating the DF2000F, the premask was removed from the sample, and the coating was deposited on the previously premasked side.

The structure of Example 1 is summarized in the Examples Structure Table below.

Example 2: Example 2 was prepared in the same way as Preparatory Example 2, except that instead of FEP, DF2000F was used as the substrate material. Prior to coating the DF2000F, the premask was removed from the sample, and the coating was deposited on the previously premasked side.

Example 3: Example 3 was prepared by taking a piece of DF2000F, removing the premask, and then placing on top of the formerly premasked side of the DF2000F a film of Preparatory Example 3, and then placing a film of Preparatory Example 5 on top of the Preparatory Example 3 film surface, with the uncoated surface of the Preparatory Example 5 in contact with the outer surface of the Preparatory Example 3.

Example 4: Example 4 was prepared by taking a piece of DF2000F, removing the premask, and then placing on top of the formerly premasked side of the DF2000F a film of Preparatory Example 4.

### Comparative Examples

Comparative Example 1: Comparative Example 1 was prepared by taking a piece of DF2000F, removing the premask, and then coating the side previously covered by the premask with 200 nm of TiO₂ per the coating method outlined in Preparatory Example 4. The structure of Comparative Example 1 is summarized in the Examples Structure Table below.

Comparative Example 2: A PET substrate was coated with a metallic reflective mirror. Comparative Example 2 was prepared with the same vapor coater described for Preparatory Example 4 with a modified coating process. The actual process for the coating consisted of: a) The vapor coater was vented to atmosphere and one the five planets was removed. The substrate was substrate for coating by adhering/taping it to the planet typically by polyimide tape. The PET substrate used for these samples was pretreated by the supplier on one side; the substrate was taped to the planet such that the non-pretreated side of the PET would be coated by the vapor coating process. b) The planet was reinstalled, and the other 4 planets were configured similarly, if needed, and they too were reinstalled in the coater. c) The chamber was closed and pumped to a vacuum level of <2×10⁻⁵ Torr (2.7×10⁻³ Pa). d) When the vapor coater was at a low enough vacuum, the material was ion beam treated using a Kaufman type ion source for ˜10 minutes at a voltage of 400V as a pretreatment to the substrate for adhesion of the vapor deposited coating to the substrate prior to applying the coatings. e) The planetary drive system was started and moved around the coater at a rotational speed of ˜60 rpm to prepare for coating and to achieve a high level of uniformity on the attached substrates. f) A Temescal electron beam gun power supply was energized. A voltage of 10 kV and a current of a few milliamps was applied to the e-gun's filament, heating the metallic source material in the e-gun. The e-beam's power and therefore the metallic source was heated and controlled via an Inficon IC5 Deposition Rate Controller (obtained from Inficon, Bad Ragaz, Switzerland) and a Quartz Crystal Monitor (QCM) (obtained from Inficon, Bad Ragaz, Switzerland). g) The QCM has a crystal that vibrated at 6 Mhz. As it became coated the frequency dropped as a function of the density and acoustic impedance of the material being deposited. There was also a tooling factor depending on geometry of the QCM crystal and the substrate on which the coating was deposited. h) The e-beam ramped in power to heat the deposition material, when the desired rate was achieved and steady, a shutter that separated the source from the planets was opened and the rate was maintained via the IC5 until the desired physical thickness was achieved, at which point the shutter closed and the IC5 turned down the power of e-beam source. The desired deposition rate for Al and Cr were 1 A/s and 2 A/s, respectively. i) The main power to the power supply was turned off and the source allowed to cool for about 10 minutes. j) If additional layers were needed, steps e-h were repeated for the appropriate material and thickness. k) The chamber was then vented back to atmospheric pressure via N₂ gas and each planet was removed and the substrate was removed from each planet.

The structure of Comparative Example 2 is summarized in the Comparative Examples Structure Table below.

Comparative Example 3: Comparative Example 3 was a film of DF2000F, with the premask removed.

Preparative Examples Structure

| | Preparatory | Preparatory | Preparatory | Preparatory | Preparatory |
|---|---|---|---|---|---|
| Sample | Example 1 | Example 2 | Example 3 | Example 4 | Example 5 |
| Substrate | FEP | FEP | 1 mil 50:50 | FEP | FEP |
| | | | PMMA UVA | | |
| | | | MB:CoPMMA | | |
| Layer 1 | SR833/750 nm | SR833/750 nm | | SR833/750 nm | SR833/750 nm |
| Layer 2 | SiO₂/25 nm | SiO₂/25 nm | | SiO₂/25 nm | SiO₂/25 nm |
| Layer 3 | SR833/750 nm | SR833/750 nm | | SR833/750 nm | SR833/750 nm |
| Layer 4 | | SiO₂/25 nm | | SiO₂/58.8 nm | SiO₂/25 nm |
| Layer 5 | | | | TiO₂/36.1 nm | TiO₂/200 nm |
| Layer 6 | | | | SiO₂/58.8 nm | |
| Layer 7 | | | | TiO₂/36.1 nm | |
| Layer 8 | | | | SiO₂/58.8 nm | |
| Layer 9 | | | | TiO₂/36.1 nm | |
| Layer 10 | | | | SiO₂/58.8 nm | |
| Layer 11 | | | | TiO₂/36.1 nm | |
| Layer 12 | | | | SiO₂/58.8 nm | |
| Layer 13 | | | | TiO₂/36.1 nm | |

Examples Structure

| Sample | Example 1 | Example 2 | Example 3 | Example 4 |
|---|---|---|---|---|
| Substrate | DF2000F | DF2000F | DF2000F | DF2000F |
| Layer 1 | SiO₂/58.8 | SR833/750 | 1 mil 50:50 | FEP |
| | nm | nm | PMMA UVA | |
| | | | MB:CoPMMA | |
| Layer 2 | TiO₂/36.1 nm | SiO₂/25 nm | FEP | SR833/750 nm |
| Layer 3 | SiO₂/58.8 nm | SR833/750 nm | SR833/750 nm | SiO₂/25 nm |
| Layer 4 | TiO₂/36.1 nm | SiO₂/25 nm | SiO₂/25 nm | SR833/750 nm |
| Layer 5 | SiO₂/58.8 nm | | SR833/750 nm | SiO₂/58.8 nm |
| Layer 6 | TiO₂/36.1 nm | | SiO₂/25 nm | TiO₂/36.1 nm |
| Layer 7 | SiO₂/58.8 nm | | TiO₂/200 nm | SiO₂/58.8 nm |
| Layer 8 | TiO₂/36.1 nm | | | TiO₂/36.1 nm |
| Layer 9 | SiO₂/58.8 nm | | | SiO₂/58.8 nm |
| Layer 10 | TiO₂/36.1 nm | | | TiO₂/36.1 nm |
| Layer 11 | | | | SiO₂/58.8 nm |
| Layer 12 | | | | TiO₂/36.1 nm |
| Layer 13 | | | | SiO₂/58.8 nm |
| Layer 14 | | | | TiO₂/36.1 nm |

Comparative Examples Structure

| | Comparative | Comparative | Comparative |
|---|---|---|---|
| Sample | Example 1 | Example 2 | Example 3 |
| Substrate | DF2000F | PET | DF2000F |
| Layer 1 | TiO₂/200 nm | Al/100 nm | |
| Layer 2 | | Cr/10 nm | |
| Layer 3 | | | |
| Layer 4 | | | |
| Layer 5 | | | |
| Layer 6 | | | |
| Layer 7 | | | |
| Layer 8 | | | |
| Layer 9 | | | |
| Layer 10 | | | |

Atomic Oxygen Test Results Table

| | Atomic oxygen mass |
|---|---|
| Sample | loss (mg/atom) |
| Example 1 | Not measured |
| Example 2 | 4.64 × 10⁻²² |
| Example 3 | 5.23 × 10⁻²² |
| Example 4 | 6.33 × 10⁻²² |
| Comparative Example 1 | Not Measured |
| Comparative Example 2 | 4.81 × 10⁻²¹ |
| Comparative Example 3 | 6.33 ×10⁻²¹ |

RF Transmission Table

| | Transmission at | | | Transmission | |
|---|---|---|---|---|---|
| | 11.1 mm (%) | | | at 3.8 mm (%) | |
| Sample | 0° | 30° | 60° | 0° | 30° |
| Example 1 | 99.8 | 99.8 | 99.8 | 97.7 | 95.3 |
| Example 2 | 100.0 | 100.0 | 99.8 | 98.2 | 92.9 |
| Example 3 | 99.1 | 99.1 | 98.9 | 95.9 | 94.8 |
| Example 4 | 99.8 | 99.5 | 99.3 | 95.3 | 92.7 |
| Comparative Example 1 | 99.8 | 99.5 | 99.5 | 98.6 | 96.2 |
| Comparative Example 2 | 0.0 | 0.0 | 0.0 | 0.0 | 0.0 |
| Comparative Example 3 | 100.0 | 100.0 | 99.8 | 98.2 | 96.8 |

Solar Aging Results Table

| | % reduction in average | |
|---|---|---|
| | reflection 400-700 nm | |
| | 425 MJ/cm² | 850 MJ/cm² |
| Sample | Dose | Dose |
| Example 1 | 1.5 | 2.7 |
| Example 2 | 38.0 | 48.1 |
| Example 3 | 2.1 | 6.4 |
| Example 4 | 0.9 | 1.4 |
| Comparative Example 1 | 28.1 | 39.8 |
| Comparative Example 2 | 44.1 | 37.9 |
| Comparative Example 3 | 24.2 | 46.9 |

First Multilayer Optical Film Reflectance Measurement Table

| | Average | Average |
|---|---|---|
| | Reflectance | Reflectance 700- |
| Sample | 400-700 nm (%) | 1000 nm (%) |
| Comparative Example 3 | 98.9 | 98.7 |
| (DF2000F) | | |

Transmission Measurement Table

| | Average Transmission | Average Transmission |
|---|---|---|
| | 190-400 nm (%) | 190-220 nm (%) |
| Example 1 | <0.1 | <0.1 |
| Example 2 | 0.7 | <0.1 |
| Example 3 | <0.1 | <0.1 |
| Example 4 | <0.1 | <0.1 |
| Comparative Example 1 | 0.4 | <0.1 |
| Comparative Example 2 | <0.1 | <0.1 |
| Comparative Example 3 | 12.7 | 36.3 |

Reflection and Absorption Results Table

| | | Wavelength range (nm) | | | | |
|---|---|---|---|---|---|---|
| | | 190- | 190- | 240- | 300- | 350- |
| | | 400 | 240 | 300 | 350 | 400 |
| Example 1 | Measured R (%) | 45 | 19 | 21 | 45 | 97 |
| | Modeled R (%) | 50 | 20 | 24 | 63 | 96 |
| | Measured A (%) | 56 | 82 | 79 | 54 | 3 |
| | Modeled A (%) | 49 | 80 | 76 | 36 | 1 |
| Example 2 | Measured R (%) | 24 | 12 | 19 | 21 | 45 |
| | Modeled R (%) | Not modeled (no UV absorbing coatings) | | | | |
| | Measured A (%) | 75 | 88 | 80 | 78 | 54 |
| | Modeled A (%) | Not modeled (no UV absorbing coatings) | | | | |
| Example 3 | Measured R (%) | 24 | 19 | 25 | 24 | 29 |
| | Modeled R (%) | 24 | 22 | 24 | 22 | 26 |
| | Measured A (%) | 76 | 82 | 75 | 76 | 71 |
| | Modeled A (%) | 72 | 78 | 76 | 77 | 60 |
| Example 4 | Measured R (%) | 44 | 20 | 22 | 44 | 96 |
| | Modeled R (%) | 50 | 20 | 24 | 63 | 96 |
| | Measured A (%) | 56 | 81 | 78 | 56 | 4 |
| | Modeled A (%) | 49 | 80 | 76 | 36 | 1 |
| Comparative | Measured R (%) | 32 | 19 | 25 | 26 | 57 |
| Example 1 | Modeled DF2000F R | 11 | 0 | 0 | 5 | 40 |
| | (%) | | | | | |
| | Corrected Measured R | 21 | 19 | 25 | 21 | 18 |
| | (%) | | | | | |
| | Modeled R (%) | 23 | 22 | 24 | 22 | 23 |
| | Measured A (%) | 68 | 82 | 75 | 73 | 41 |
| | Modeled DF2000F A | 10 | 0 | 0 | 13 | 28 |
| | (%) | | | | | |
| | Corrected Measured A | 58 | 82 | 75 | 60 | 13 |
| | (%) | | | | | |
| | Modeled A (%) | 55 | 78 | 76 | 58 | 6 |
| Comparative | Measured R (%) | 30 | 11 | 9 | 31 | 74 |
| Example 2 | Modeled R (%) | Not modeled (no UV absorbing coatings) | | | | |
| | Measured A (%) | 70 | 90 | 91 | 68 | 25 |
| | Modeled A (%) | Not modeled (no UV absorbing coatings) | | | | |
| Comparative | Measured R (%) | 46 | 62 | 35 | 27 | 56 |
| Example 3 | Modeled R (%) | Not modeled (no UV absorbing coatings) | | | | |
| | Measured A (%) | 42 | 9 | 54 | 65 | 40 |

| | |
|---|---|
| Modeled A (%) | Not modeled (no UV absorbing coatings) |

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

Furthermore, all publications and patents referenced herein are incorporated by reference in their entirety to the same extent as if each individual publication or patent was specifically and individually indicated to be incorporated by reference. In the event of inconsistencies or contradictions between portions of the incorporated references and this application, the information in the preceding description.

Various exemplary embodiments have been described. These and other embodiments are within the scope of the following claims.

1. A light shielding article comprising:
a) a first multilayer optical film comprised of at least a plurality of alternating first and second polymeric optical layers collectively reflecting at an incident light angle of at least one of 0°, 15°, 30°, 45°, 60°, or 75°, an average of at least 70, 80, 90, or 95 percent of incident visible light over at least a wavelength range from 400 nanometers (nm) to 700 nm, the multilayer optical film having a first major surface; and
b) a second multilayer optical film disposed on the first multilayer optical film, the second multilayer optical film comprised of at least a plurality of alternating first and second inorganic optical layers collectively reflecting and absorbing at an incident light angle of at least one of 0°, 15°, 30°, 45°, 60°, or 75°, an average of at least 50, 60, 70, 80, 90, or 95 percent of incident ultraviolet light over at least a 30-nanometer wavelength reflection bandwidth in a wavelength range from 190 nm to 400 nm,
wherein the light shielding article transmits at an incident light angle of at least one of 0°, 15°, 30°, 45°, 60°, or 75°, an average of at least 70, 80, 90, or 95 percent of incident radio frequency waves in at least one wavelength range from 1 millimeter (mm) to 10 mm, 10 mm to 100 mm, or 100 mm to 1000 mm.

2. A light shielding article comprising:
a) a first multilayer optical film comprised of at least a plurality of alternating first and second polymeric optical layers collectively reflecting at an incident light angle of at least one of 0°, 15°, 30°, 45°, 60°, or 75°, an average of at least 70, 80, 90, or 95 percent of incident visible light over at least a wavelength range from 400 nm to 700 nm, the multilayer optical film having a first major surface; and
b) a barrier coating disposed on the first major surface of the multilayer optical film, the barrier coating comprising: at least one dyad comprised of a (co)polymer layer overlaying the first major surface of the multilayer optical film and an inorganic layer overlaying the (co)polymer layer; and an outer (co)polymer layer overlaying the at least one dyad; and optionally, at least one outer inorganic layer overlaying the outer (co)polymer layer;
wherein the light shielding article transmits at an incident light angle of at least one of 0°, 15°, 30°, 45°, 60°, or 75°, an average of at least 70, 80, 90, or 95 percent of incident radio frequency waves in at least one wavelength range from 1 mm to 10 mm, 10 mm to 100 mm, or 100 mm to 1000 mm, and
wherein the light shielding article transmits, at an incident light angle of at least one of 0°, 15°, 30°, 45°, 60°, or 75°, an average of at most 50, 60, or 70 percent of incident ultraviolet light over at least a 30-nanometer wavelength reflection bandwidth in a wavelength range from 190 nm to 400 nm.

3. The light shielding article of claim 2, further comprising a second multilayer optical film disposed on the barrier coating, the second multilayer optical film comprised of at least a plurality of alternating first and second inorganic optical layers collectively reflecting and absorbing at an incident light angle of at least one of 0°, 15°, 30°, 45°, 60°, or 75°, an average of at least 50, 60, 70, 80, 90, or 95 percent of incident ultraviolet light over at least a 30-nanometer wavelength reflection bandwidth in a wavelength range from 190 nm to 400 nm.

4. The light shielding article of claim 2, wherein the at least one dyad is a plurality of dyads, optionally wherein the plurality of dyads is two dyads, three dyads, four dyads, five dyads, or six dyads.

5. The light shielding article of claim 2, wherein the at least one inorganic layer is formed of an inorganic material selected from silicon oxide, silica alumina oxide, silicon oxynitride, gallium oxide, magnesium oxide, niobium oxide, titanium dioxide, yttrium oxide, zinc oxide, tin oxide, nickel oxide, tungsten oxide, aluminum doped zinc oxide, indium tin oxide, zirconium oxide, zirconium oxynitride, hafnia, aluminum oxide, alumina doped silicon oxide, lanthanum fluoride, neodymium fluoride, aluminum fluoride, magnesium fluoride, calcium fluoride, or a combination thereof.

6. The light shielding article of claim 2, wherein each (co)polymer layer in the at least one dyad comprises a (co)polymer selected from an olefinic (co)polymer, a (meth)acrylate (co)polymer, a urethane (co)polymer, a fluoropolymer, a silicone (co)polymer, or a combination thereof.

7. The light shielding article of claim 2, wherein the article exhibits an atomic oxygen degradation, when tested according to the Atomic Oxygen Degradation Test, of less than 1×10⁻²⁰ mg/atom, 1×10⁻²¹ mg/atom, or 1×10⁻²² mg/atom.

8. The light shielding article of claim 1, wherein the polymeric optical layers of the first multilayer optical film comprise a fluoropolymer, a polyethylene terephthalate (PET), CoPMMA, a polypropylene (PP) copolymer, a polyethylene copolymer, PMMA, a blend of PMMA and polyvinylidene fluoride (PVDF), an acrylate copolymer, a polyurethane, PEN, or combinations thereof.

9. The light shielding article of claim 1, wherein the polymeric optical layers of the first multilayer optical film comprise a fluoropolymer independently selected from the group consisting of a copolymer of tetrafluoroethylene (TFE), hexafluoropropylene (HFP), and vinylidene fluoride; a copolymer of TFE, HFP, vinylidene fluoride, and perfluoropropyl vinyl ether (PPVE); a polyvinylidene fluoride (PVDF); an ethylene chlorotrifluoroethylene (ECTFE) polymer; an ethylene tetrafluoroethylene (ETFE); a perfluoroalkoxy alkane (PFA) polymer; a fluorinated ethylene propylene (FEP) polymer; a polytetrafluoroethylene (PTFE); a copolymer of TFE, HFP, and ethylene; a polyvinyl fluoride (PVF); and combinations thereof.

10. The light shielding article of claim 1, wherein the first optical layer of the second multilayer optical film comprises at least one of niobium oxide, titanium oxide, silicon oxynitride, molybdenum oxide, tungsten oxide, silicon nitride, indium tin oxide, hafnium oxide, tantalum oxide, zirconium oxynitride, zirconium oxide, aluminum zinc oxide, or zinc oxide and wherein the second optical layer comprises at least one of silicon oxide, aluminum oxide, aluminum fluoride, magnesium fluoride, calcium fluoride, indium tin oxide, aluminum zinc oxide, or zinc oxide.

11. The light shielding article of claim 1, wherein the second multilayer optical film is present and the first optical layer of the second multilayer optical film comprises at least one of niobium oxide or titanium oxide, and wherein the second optical layer comprises silicon oxide.

12. The light shielding article of claim 1, wherein the second multilayer optical film is present and has a thickness of 200 nm to 900 nm.

13. The light shielding article of claim 1, wherein each of the first and second optical layers independently has a thickness of 5 nm to 200 nm.

14. The light shielding article of claim 1, wherein the second multilayer optical film is present and is formed of 3 to 21 total first and second optical layers.

15. The light shielding article of claim 1, wherein the second multilayer optical film is present and the plurality of alternating first and second inorganic optical layers of the second multilayer optical film collectively reflect and absorb at an incident light angle of at least one of 0°, 15°, 30°, 45°, 60°, or 75°, an average of at least 60, 70, 80, 90, or 95 percent of incident ultraviolet light over at least a 50-nanometer, 75-nanometer, 100-nanometer, 125-nanometer, 150-nanometer, or 175-nanometer wavelength reflection bandwidth in a wavelength range from 190 nm to 400 nm.

16. The light shielding article of claim 1, further comprising a substrate attached to at least a portion of a second major surface of the first multilayer optical film.

17. The light shielding article of claim 1, further comprising an adhesive disposed on at least a portion of the second major surface of the first multilayer optical film or disposed on at least a portion of the substrate opposite the first multilayer optical film, or both.

18. The light shielding article of claim 1, wherein an average transmission of wavelengths between 400 nm and 700 nm through the article is reduced by less than 20%, 10%, 5%, or less than 1% after exposure to a dose of ultraviolet light of 425 megajoules per square centimeter (MJ/cm²) or 850 MJ/cm².

19. The light shielding article of claim 1, wherein at least one (co)polymer layer in the at least one dyad or the outer (co)polymer layer further comprises an ultraviolet radiation absorber, a hindered amine light stabilizer, an antioxidant, or a combination thereof.

20. The light shielding article of claim 19, wherein the ultraviolet radiation absorber is selected from a benzotriazole compound, a benzophenone compound, a triazine compound, or a combination thereof.

21. The light shielding article of claim 1, wherein the plurality of alternating first and second polymeric optical layers collectively reflect at an incident light angle of at least one of 0°, 15°, 30°, 45°, 60°, or 75°, an average of at least 70, 80, 90, or 95 percent of incident infrared light over at least a 30-nanometer wavelength reflection bandwidth in a wavelength range from 700 nm to 1600 nm and/or 700 nm to 2000 nm.

22. An electromagnetic receiver and/or emitter comprising the light shielding article of claim 1 attached to at least a portion of the electromagnetic receiver and/or emitter.

23. The light shielding article of claim 1, further comprising a barrier coating disposed on the first major surface of the first multilayer optical film between the first multilayer optical film and the second multilayer optical film, the barrier coating comprising: at least one dyad comprised of a (co)polymer layer overlaying the first major surface of the multilayer optical film and an inorganic layer overlaying the (co)polymer layer; and an outer (co)polymer layer overlaying the at least one dyad; and optionally, at least one outer inorganic layer overlaying the outer (co)polymer layer.

24. The light shielding article of claim 23, wherein the article exhibits an atomic oxygen degradation, when tested according to the Atomic Oxygen Degradation Test, of less than 1×10⁻²⁰ mg/atom, 1×10⁻²¹ mg/atom, or 1×10⁻²² mg/atom.
